(19) United States
(12) Patent Application Publication
(10) Pub. No.: US 2025/0317189 A1
(43) Pub. Date: Oct. 9, 2025

(54) BEAM RESOURCE SUSPENSION

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US); Hamed PEZESHKI, San Diego, CA (US)

(21) Appl. No.: 18/866,041

(22) PCT Filed: Jul. 21, 2022
(86) PCT No.: PCT/CN2022/106990

§ 371 Date: Nov. 14, 2024

(51) Int. Cl. H04B 7/06; H04W 72/23

(52) U.S. Cl. CPC H04B 7/06964; H04W 72/23

(57) ABSTRACT

Aspects relate to a network entity sending to a user equipment (UE) information that is indicative of whether the UE may at least partially suspend beam failure operations (e.g., for a period of time) on a particular beam resource of a set of beam resources. For example, based on measurement reports received from the UE, the network entity may predict that a beam blockage may occur (e.g., for a period of time) on at least one beam resource of the set of beam resources.

The technology discussed below relates generally to wireless communication and, more particularly, to suspension of beam resources.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station and user equipment (UE) may utilize beamforming to compensate for high path loss and short range. Beamforming is a signal processing technique used with an antenna array for directional signal transmission and/or reception. Each antenna in the antenna array transmits a signal that is combined with other signals of other antennas of the same array in such a way that signals at particular angles experience constructive interference while others experience destructive interference.

The base station and the UE can select at least one beam pair link (BPL) for communication between the base station and the UE on a downlink and/or an uplink. Each BPL includes corresponding transmit and receive beams on the base station and the UE. For example, on the downlink, a BPL includes a transmit beam on the base station and a receive beam on the UE. To increase the data rate, multiple BPLs can be used to facilitate spatial multiplexing of multiple data streams from the base station to the UE.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a first apparatus for wireless communication may include a processing system. The processing system may be configured to obtain, from a second apparatus, first information indicative of whether the first apparatus is to suspend a beam failure operation for at least one first beam resource of a plurality of beam resources associated with the second apparatus. The processing system may also be configured to at least partially suspend the beam failure operation for the at least one first beam resource based on the first information.

In some examples, a method for communication at a user equipment is disclosed. The method may include obtaining, from a network entity, first information indicative of whether the user equipment is to suspend a beam failure operation for at least one first beam resource of a plurality of beam resources associated with the network entity. The method may also include at least partially suspending the beam failure operation for the at least one first beam resource based on the first information.

In some examples, a first apparatus for communication may include means for obtaining, from a second apparatus, first information indicative of whether the first apparatus is to suspend a beam failure operation for at least one first beam resource of a plurality of beam resources associated with the second apparatus. The first apparatus may also include means for at least partially suspending the beam failure operation for the at least one first beam resource based on the first information.

In some examples, a non-transitory computer-readable medium has stored therein instructions executable by a processing system of a first apparatus to obtain, from a second apparatus, first information indicative of whether the first apparatus is to suspend a beam failure operation for at least one first beam resource of a plurality of beam resources associated with the second apparatus. The computer-readable medium may also have stored therein instructions executable by the processing system of the first apparatus to at least partially suspend the beam failure operation for the at least one first beam resource based on the first information.

In some examples, a first apparatus for wireless communication may include a processing system. The processing system may be configured to obtain, from a second apparatus, signal measurement information associated with at least one first beam resource of a plurality of beam resources associated with the first apparatus. The processing system may also be configured to generate, based on the signal measurement information, first information indicative of whether the second apparatus is to at least partially suspend a beam failure operation for the at least one first beam resource. The processing system may further be configured to output, for transmission to the second apparatus, the first information indicative of whether the second apparatus is to at least partially suspend the beam failure operation for the at least one first beam resource.

In some examples, a method for communication at a user equipment is disclosed. The method may include obtaining, from a second apparatus, signal measurement information associated with at least one first beam resource of a plurality of beam resources associated with the first apparatus. The method may also include generating, based on the signal measurement information, first information indicative of whether the second apparatus is to at least partially suspend a beam failure operation for the at least one first beam resource. The method may further include outputting, for transmission to the second apparatus, the first information indicative of whether the second apparatus is to at least partially suspend the beam failure operation for the at least one first beam resource.

In some examples, a first apparatus for communication may include means for obtaining, from a second apparatus, signal measurement information associated with at least one first beam resource of a plurality of beam resources associated with the first apparatus. The first apparatus may also include means for generating, based on the signal measurement information, first information indicative of whether the second apparatus is to at least partially suspend a beam failure operation for the at least one first beam resource. The first apparatus may further include means for outputting, for transmission to the second apparatus, the first information indicative of whether the second apparatus is to at least partially suspend the beam failure operation for the at least one first beam resource.

In some examples, a non-transitory computer-readable medium has stored therein instructions executable by a processing system of a first apparatus to obtain, from a second apparatus, signal measurement information associated with at least one first beam resource of a plurality of beam resources associated with the first apparatus. The computer-readable medium may also have stored therein instructions executable by the processing system of the first apparatus to generate, based on the signal measurement information, first information indicative of whether the second apparatus is to at least partially suspend a beam failure operation for the at least one first beam resource. The computer-readable medium may further have stored therein instructions executable by the processing system of the first apparatus to output, for transmission to the second apparatus, the first information indicative of whether the second apparatus is to at least partially suspend the beam failure operation for the at least one first beam resource.

In some examples, a user equipment for wireless communication may include a transceiver and a processing system. The processing system may be configured to receive, from a network entity via the transceiver, first information indicative of whether the user equipment is to suspend a beam failure operation for at least one first beam resource of a plurality of beam resources associated with the network entity. The processing system may also be configured to at least partially suspend the beam failure operation for the at least one first beam resource based on the first information.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5 is a schematic illustration of an example of an apparatus for communication according to some aspects.

FIG. 6 is a block diagram illustrating an example of a wireless communication system supporting beamforming communication according to some aspects.

FIG. 7 is a diagram illustrating an example of communication between a radio access network (RAN) node and a wireless communication device using beamforming according to some aspects.

FIG. 8 is a conceptual illustration of an example of a beam prediction operation according to some aspects.

FIG. 9 is a conceptual illustration of an example of beam failure detection according to some aspects.

FIG. 10 is a conceptual illustration of an example of a predicted blockage window according to some aspects.

FIG. 11 is a diagram illustrating an example of a suspension operation according to some aspects.

FIG. 12 is a diagram illustrating an example of a beam failure trigger operation according to some aspects.

FIG. 13 is a diagram illustrating another example of a beam failure trigger operation according to some aspects.

FIG. 14 is a diagram illustrating another example of a beam failure trigger operation according to some aspects.

FIG. 15 is a diagram illustrating another example of a beam failure trigger operation according to some aspects.

FIG. 16 is a conceptual illustration of an example of conditions for different beam suspension parameters according to some aspects.

FIG. 17 is a signaling diagram illustrating an example of beam failure operation suspension according to some aspects.

FIG. 18 is a block diagram conceptually illustrating an example of a hardware implementation for an apparatus (e.g., a user equipment) employing a processing system according to some aspects.

FIG. 19 is a flow chart illustrating an example communication method involving at least partially suspending a beam failure operation according to some aspects.

FIG. 20 is a block diagram conceptually illustrating an example of a hardware implementation for an apparatus (e.g., a network entity) employing a processing system according to some aspects.

FIG. 21 is a flow chart illustrating an example communication method involving signaling information indicative of whether a beam failure operation is to be at least partially suspended according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to suspending a beam failure operation. A UE may monitor (e.g., periodically monitor) a set of beam resources associated with a network entity such as a base station and perform beam failure operations to determine whether a beam failure has occurred. In conjunction with this monitoring, the UE may send measurement reports to the network entity that indicate, for example, the received signal strengths measured on the different beam resources.

The disclosure relates in some aspects to a network entity sending to a UE information that is indicative of whether the UE may at least partially suspend beam failure operations on a particular beam resource (e.g., for a period of time). For example, based on measurement reports received from the UE, the network entity may predict that a beam blockage may occur (e.g., for a period of time) on at least one beam resource of the set of beam resources.

In some examples, in the event beam failure operations are at least partially suspended for at least one beam resource (e.g., a beam failure detection reference signal resource #0) of the set of beam resources, the UE may use specified beam failure reporting parameters to determine whether a beam failure is indicated for one or more other beam resources (e.g., a beam failure detection reference signal resource #1) of the set of beam resources. In some aspects, these specified beam failure reporting parameters may be different from the beam failure reporting parameters that are used when there is no suspension of beam resources.

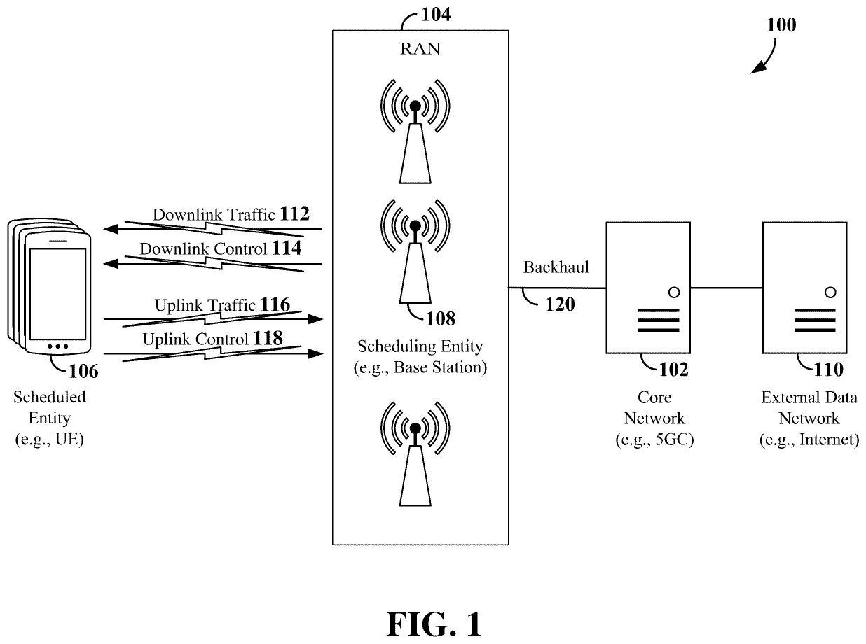

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

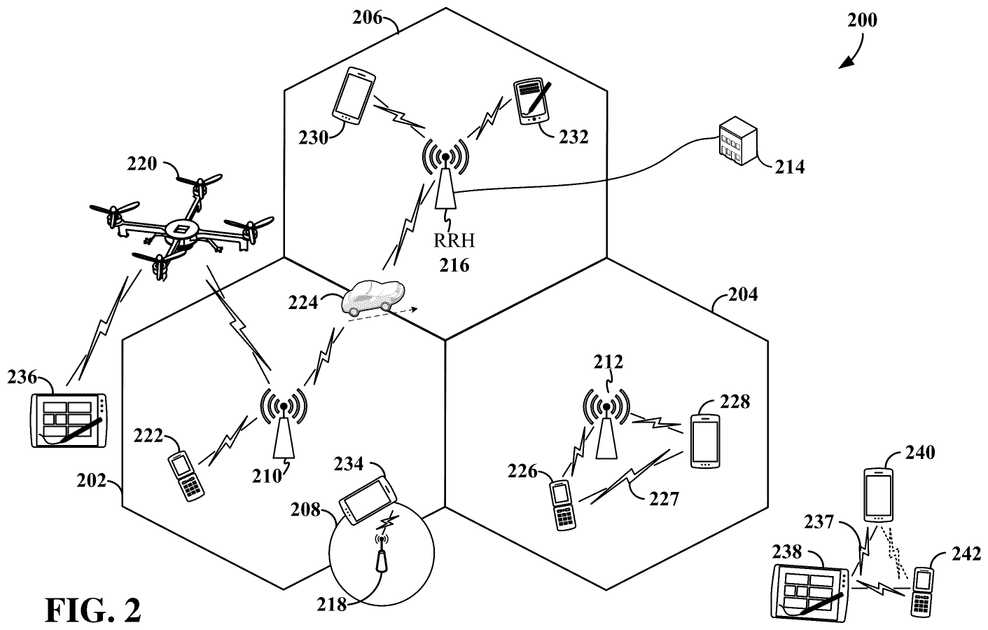

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUS, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

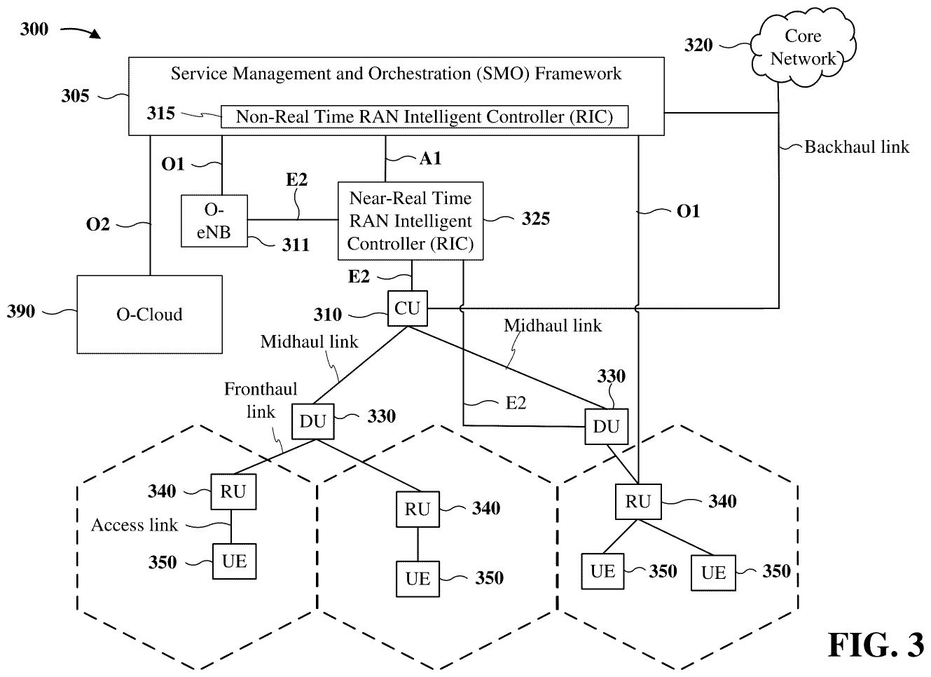

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

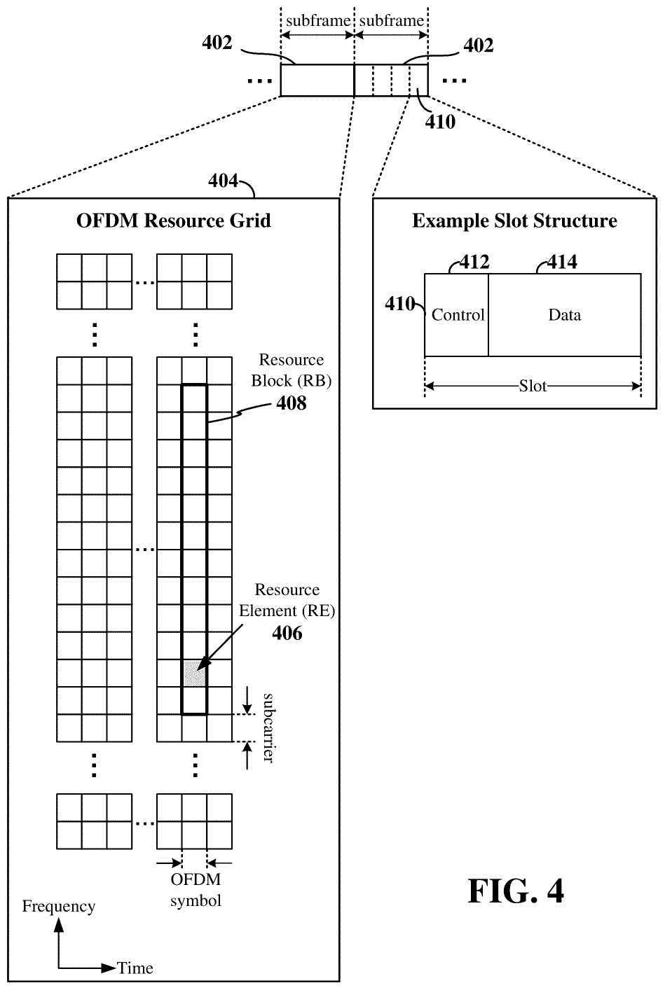

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

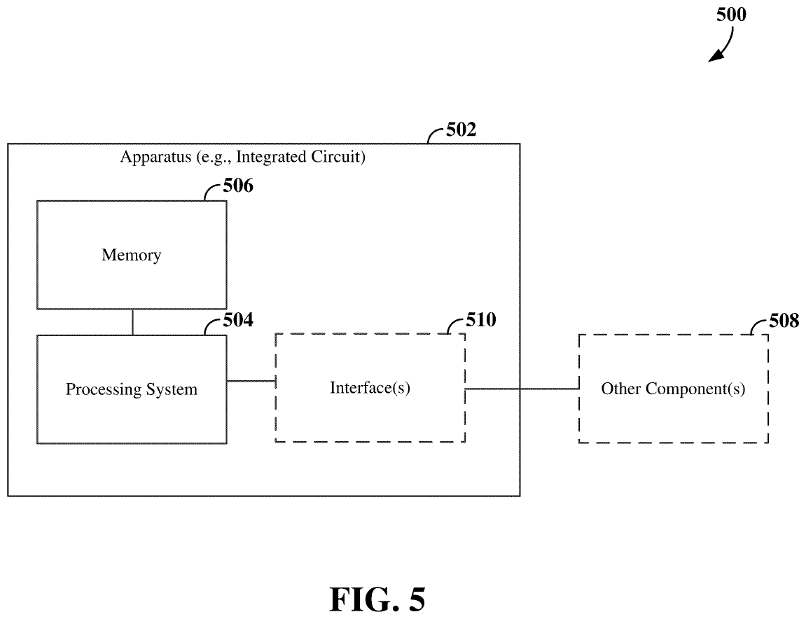

FIG. 5 illustrates an example apparatus 500 according to certain aspects of the disclosure. In some examples, the apparatus 500 may be a network entity, a UE, or some other type of wireless node (e.g., a node that utilizes wireless spectrum (e.g., the RF spectrum) to communicate with another node or entity). In some examples, the apparatus 500 may correspond to any of the apparatuses, UEs, scheduled entities, network entities, base stations (e.g., gNBs), scheduling entities, distributed units, control units, RAN nodes, or CN entities shown in any of FIGS. 1, 2, 3, 6, 7, 8, 17, 18, and 20.

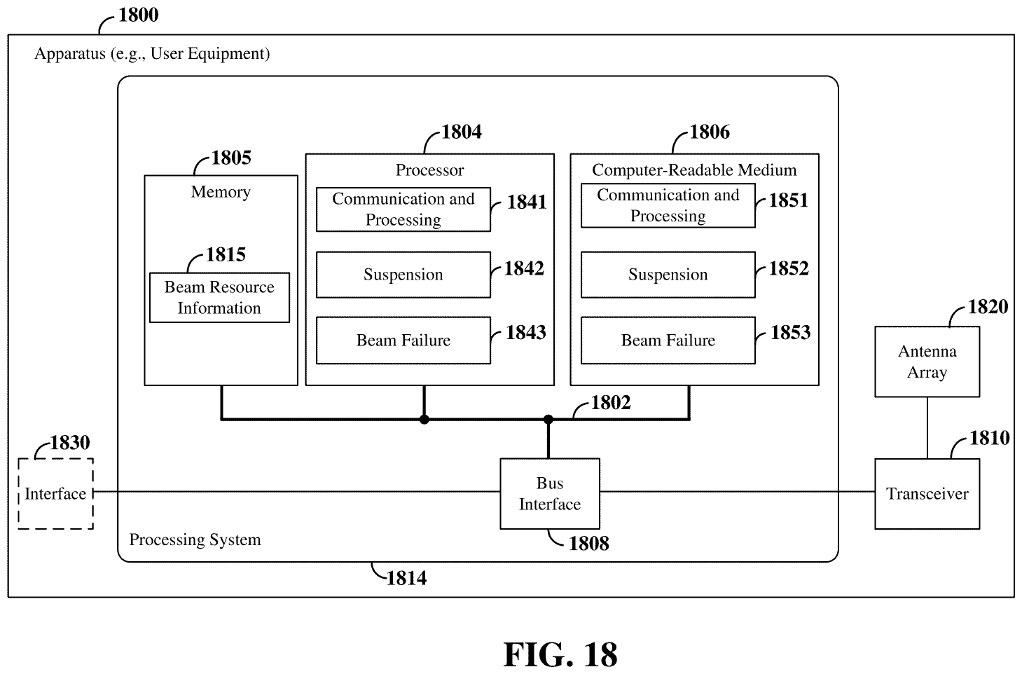

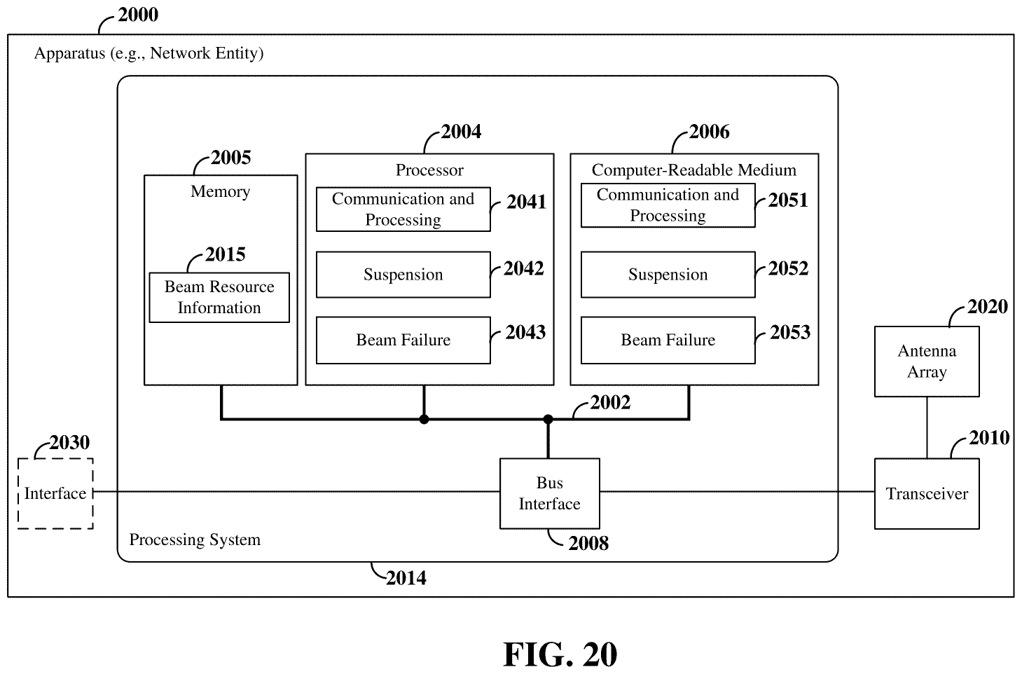

The apparatus 500 includes an apparatus 502 (e.g., an integrated circuit) and, optionally, at least one other component 508. In some aspects, the apparatus 502 may be configured to operate in a wireless communication device (e.g., a UE, a BS, etc.) and to perform one or more of the operations described herein. The apparatus 502 includes a processing system 504, and a memory 506 coupled to the processing system 504. Example implementations of the processing system 504 are provided herein. In some examples, the processing system 504 of FIG. 5 may correspond to the processing system 1814 of FIG. 18. In some examples, the processing system 504 of FIG. 5 may correspond to the processing system 2014 of FIG. 20.

The processing system 504 is generally adapted for processing, including the execution of such programming stored on the memory 506. For example, the memory 506 may store instructions that, when executed by the processing system 504, cause the processing system 504 to perform one or more of the operations described herein.

In some implementations, the apparatus 502 communicates with at least one other component (e.g., a component 508 external to the apparatus 502) of the apparatus 500. To this end, in some implementations, the apparatus 502 may include at least one interface 510 (e.g., a send and/or receive interface) coupled to the processing system 504 for outputting and/or obtaining (e.g., sending and/or receiving) information (e.g., received information, generated information, decoded information, messages, etc.) between the processing system 504 and the other component(s) 508. In some implementations, the interface 510 may include an interface bus, bus drivers, bus receivers, buffers, other suitable circuitry, or a combination thereof. In some implementations, the interface 510 may include radio frequency (RF) circuitry (e.g., an RF transmitter and/or an RF receiver). In some implementations, the interface 510 may be configured to interface the apparatus 502 to one or more other components of the apparatus 500 (other components not shown in FIG. 5). For example, the interface 510 may be configured to interface the processing system 504 to a radio frequency (RF) front end (e.g., an RF transmitter and/or an RF receiver).

The apparatus 502 may communicate with other apparatuses in various ways. In cases where the apparatus 502 includes an RF transceiver (not specifically depicted in FIG. 5), the apparatus may transmit and receive information (e.g., a frame, a message, bits, etc.) via RF signaling. In some cases, rather than transmitting information via RF signaling, the apparatus 502 may have an interface to provide (e.g., output, send, transmit, etc.) information for RF transmission. For example, the processing system 504 may output information, via a bus interface, to an RF front end for RF transmission. Similarly, rather than receiving information via RF signaling, the apparatus 502 may have an interface to obtain information that is received by another apparatus. For example, the processing system 504 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

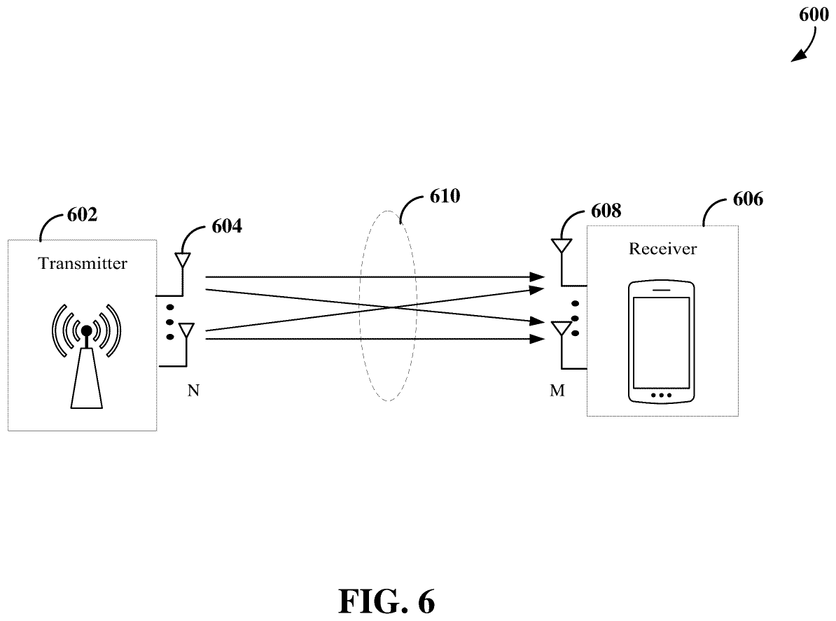

A scheduling entity (e.g., a network entity) and/or scheduled entity (e.g., a UE) may be configured for beamforming and/or multiple-input multiple-output (MIMO) technology. FIG. 6 illustrates an example of a wireless communication system 600 supporting beamforming and/or MIMO. In the wireless communication system 600, a transmitter 602 includes multiple transmit antennas 604 (e.g., N transmit antennas) and a receiver 606 includes multiple receive antennas 608 (e.g., M receive antennas). Thus, there are N×M signal paths 610 from the transmit antennas 604 to the receive antennas 608. Each of the transmitter 602 and the receiver 606 may be implemented, for example, within a scheduling entity, a scheduled entity, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the network entity to identify the source of each spatially precoded data stream.

The number of data streams or layers corresponds to the rank of the transmission. In general, the rank of the wireless communication system 600 (e.g., a MIMO system) is limited by the number of transmit antenna 604 or receive antennas 608, whichever is lower. In addition, the channel conditions at the UE, as well as other considerations, such as the available resources at the network entity, may also affect the transmission rank. For example, the rank (and therefore, the number of data streams) assigned to a particular UE on the downlink may be determined based on the rank indicator (RI) transmitted from the UE to the network entity. The RI may be determined based on the antenna configuration (e.g., the number of transmit and receive antennas) and a measured signal-to-interference-plus-noise ratio (SINR) on each of the receive antennas. The RI may indicate, for example, the number of layers that may be supported under the current channel conditions. The network entity may use the RI, along with resource information (e.g., the available resources and amount of data to be scheduled for the UE), to assign a transmission rank to the UE.

In one example (e.g., FIG. 6), a rank-2 spatial multiplexing transmission on a 2×2 MIMO antenna configuration will transmit one data stream from each transmit antenna 604. Each data stream reaches each receive antenna 608 along a different signal path 610. The receiver 606 may then reconstruct the data streams using the received signals from each receive antenna 608.

Beamforming is a signal processing technique that may be used at the transmitter 602 or the receiver 606 to shape or steer an antenna beam (e.g., a transmit beam or receive beam) along a spatial path between the transmitter 602 and the receiver 606. Beamforming may be achieved by combining the signals communicated via the transmit antennas 604 or the receive antennas 608 (e.g., antenna elements of an antenna array module) such that some of the signals experience constructive interference while others experience destructive interference. To create the desired constructive/destructive interference, the transmitter 602 or the receiver 606 may apply amplitude and/or phase offsets to signals transmitted from each of the transmit antennas 604 or received by each of the receive antenna 608.

In 5G New Radio (NR) systems, particularly for above 6 GHz or mmWave systems, beamformed signals may be utilized for most downlink channels, including the physical downlink control channel (PDCCH) and physical downlink shared channel (PDSCH). In addition, broadcast control information, such as the SSB, slot format indicator (SFI), and paging information, may be transmitted in a beam-sweeping manner to enable all scheduled entities (UEs) in the coverage area of a transmission and reception point (TRP) (e.g., a gNB) to receive the broadcast control information. In addition, for UEs configured with beamforming antenna arrays, beamformed signals may also be utilized for uplink channels, including the physical uplink control channel (PUCCH) and physical uplink shared channel (PUSCH).

A network entity (e.g., gNB) may generally be capable of communicating with UEs using beams (e.g., downlink transmit beams) of varying beam widths. For example, a network entity may be configured to utilize a wider beam when communicating with a UE that is in motion and a narrower beam when communicating with a UE that is stationary.

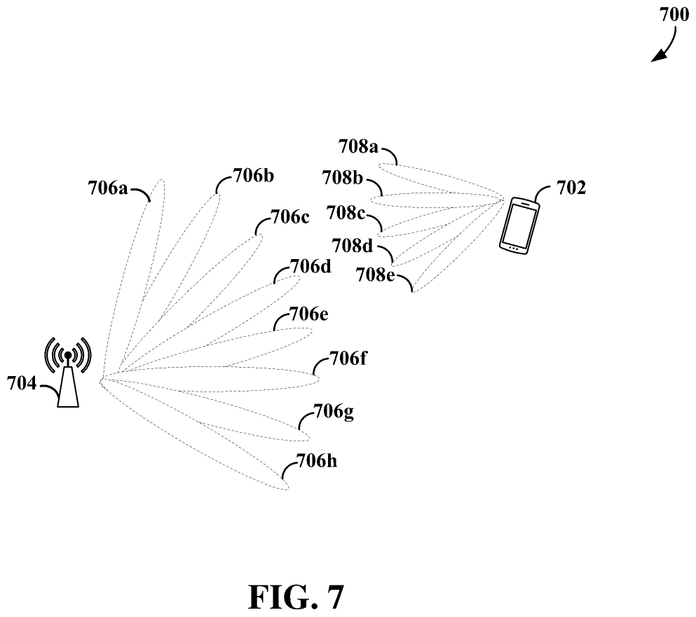

FIG. 7 is a diagram illustrating communication between a network entity 704 and a UE 702 using beamformed signals according to some aspects. The network entity 704 may be any of the network entities (e.g., gNBs), CUs, DUs, RUs, or scheduling entities illustrated in any of FIGS. 1, 2, 3, 5, 6, 8, 17, and 20, and the UE 702 may be any of the UEs or scheduled entities illustrated in in any of FIGS. 1, 2, 3, 5, 6, 8, 17, and 18.

The network entity 704 may generally be capable of communicating with the UE 702 using one or more transmit beams, and the UE 702 may further be capable of communicating with the network entity 704 using one or more receive beams. As used herein, the term transmit beam refers to a beam on the network entity 704 that may be utilized for downlink or uplink communication with the UE 702. In addition, the term receive beam refers to a beam on the UE 702 that may be utilized for downlink or uplink communication with the network entity 704.

In the example shown in FIG. 7, the network entity 704 is configured to generate a plurality of transmit beams 706a-706h, each associated with a different spatial direction. In addition, the UE 702 is configured to generate a plurality of receive beams 708a-708e, each associated with a different spatial direction. It should be noted that while some beams are illustrated as adjacent to one another, such an arrangement may be different in different aspects. For example, transmit beams 706a-706h transmitted during the same symbol might not be adjacent to one another. In some examples, the network entity 704 and the UE 702 may each transmit more or fewer beams distributed in all directions (e.g., 360 degrees) and in three-dimensions. In addition, the transmit beams 706a-706h may include beams of varying beam width. For example, the network entity 704 may transmit certain signals (e.g., SSBs) on wider beams and other signals (e.g., CSI-RSs) on narrower beams.

The network entity 704 and the UE 702 may select one or more transmit beams 706a-706h on the network entity 704 and one or more receive beams 708a-708e on the UE 702 for communication of uplink and downlink signals therebetween using a beam management procedure. In one example, during initial cell acquisition, the UE 702 may perform a P1 beam management procedure to scan the plurality of transmit beams 706a-706h on the plurality of receive beams 708a-708e to select a beam pair link (e.g., one of the transmit beams 706a-706h and one of the receive beams 708a-708e) for a physical random access channel (PRACH) procedure for initial access to the cell. For example, periodic SSB beam sweeping may be implemented on the network entity 704 at certain intervals (e.g., based on the SSB periodicity). Thus, the network entity 704 may be configured to sweep or transmit an SSB on each of a plurality of wider transmit beams 706a-706h. The UE may measure the reference signal received power (RSRP) of each of the SSB transmit beams on each of the receive beams of the UE and select the transmit and receive beams based on the measured RSRP. In an example, the selected receive beam may be the receive beam on which the highest RSRP is measured and the selected transmit beam may have the highest RSRP as measured on the selected receive beam.

After completing the PRACH procedure, the network entity 704 and the UE 702 may perform a P2 beam management procedure for beam refinement. For example, the network entity 704 may be configured to sweep or transmit a CSI-RS on each of a plurality of narrower transmit beams 706a-706h. Each of the narrower CSI-RS beams may be a sub-beam of the selected SSB transmit beam (e.g., within the spatial direction of the SSB transmit beam). Transmission of the CSI-RS transmit beams may occur periodically (e.g., as configured via radio resource control (RRC) signaling by a gNB), semi-persistently (e.g., as configured via RRC signaling and activated/deactivated via medium access control-control element (MAC-CE) signaling by the gNB), or aperiodically (e.g., as triggered by the gNB via downlink control information (DCI)). The UE 702 is configured to scan the plurality of CSI-RS transmit beams 706a-706h on the plurality of receive beams 708a-708e. The UE 702 then performs beam measurements (e.g., RSRP, SINR, etc.) of the received CSI-RSs on each of the receive beams 708a-708e to determine the respective beam quality of each of the CSI-RS transmit beams 706a-706h as measured on each of the receive beams 708a-708e.

The UE 702 can then generate and transmit a Layer 1 (L1) measurement report, including the respective beam index (e.g., CSI-RS resource indicator (CRI)) and beam measurement (e.g., RSRP) of one or more of the CSI-RS transmit beams 706a-706h on one or more of the receive beams 708a-708e to the network entity 704. The network entity 704 may then select one or more CSI-RS transmit beams on which to transmit unicast downlink control information and/or user data traffic to the UE 702. In some examples, the selected CSI-RS transmit beam(s) have the highest RSRP from the L1 measurement report. Transmission of the L1 measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The UE 702 may further select a corresponding receive beam on the UE 702 for each selected serving CSI-RS transmit beam to form a respective downlink beam pair link (BPL) for each selected serving CSI-RS transmit beam. For example, the UE 702 can utilize the beam measurements obtained during the P2 procedure or perform a P3 beam management procedure to obtain new beam measurements for the selected CSI-RS transmit beams to select the corresponding receive beam for each selected transmit beam. In some examples, the selected receive beam to pair with a particular CSI-RS transmit beam may be the receive beam on which the highest RSRP for the particular CSI-RS transmit beam is measured.

In some examples, the network entity 704 may configure the UE 702 to perform SSB beam measurements and provide an L1 measurement report containing beam measurements of SSB transmit beams 706a-706h. For example, the network entity 704 may configure the UE 702 to perform SSB beam measurements and/or CSI-RS beam measurements for beam failure detection (BRD), beam failure recovery (BFR), cell reselection, beam tracking (e.g., for a mobile UE 702 and/or network entity 704), or some other beam optimization purpose.

In addition, when the channel is reciprocal, the transmit and receive beams may be selected using an uplink beam management scheme. In an example, the UE 702 may be configured to sweep or transmit on each of a plurality of receive beams 708a-708e. For example, the UE 702 may transmit an SRS on each beam in the different beam directions. In addition, the network entity 704 may be configured to receive the uplink beam reference signals on a plurality of transmit beams 706a-706h. The network entity 704 then performs beam measurements (e.g., RSRP, SINR, etc.) of the beam reference signals on each of the transmit beams 706a-706h to determine the respective beam quality of each of the receive beams 708a-708e as measured on each of the transmit beams 706a-706h.

The network entity 704 may then select one or more transmit beams on which to transmit unicast downlink control information and/or user data traffic to the UE 702. In some examples, the selected transmit beam(s) has (have) the highest RSRP. The UE 702 may then select a corresponding receive beam for each selected serving transmit beam to form a respective beam pair link (BPL) for each selected serving transmit beam, using, for example, a P3 beam management procedure, as described above.

In one example, a single transmit beam (e.g., the transmit beam 706d) on the network entity 704 and a single receive beam (e.g., the receive beam 708c) on the UE 702 may form a single BPL used for communication between the network entity 704 and the UE 702. In another example, multiple transmit beams (e.g., transmit beams 706c, 706d, and 706e) on the network entity 704 and a single receive beam (e.g., receive beam 708c) on the UE 702 may form respective BPLs used for communication between the network entity 704 and the UE 702. In another example, multiple transmit beams (e.g., transmit beams 706c, 706d, and 706e) on the network entity 704 and multiple receive beams (e.g., receive beams 708c and 708d) on the UE 702 may form multiple BPLs used for communication between the network entity 704 and the UE 702. In this example, a first BPL may include the transmit beam 706c and the receive beam 708c, a second BPL may include the transmit beam 708d and the receive beam 708c, and a third BPL may include the transmit beam 708e and the receive beam 708d.

In some examples, to select one or more downlink transmit beams and one or more downlink receive beams for communication with a UE 702, the network entity 704 may transmit a reference signal, such as an SSB or CSI-RS, on each of a plurality of downlink transmit beams in a beam-sweeping manner. The UE 702 may measure the reference signal received power (RSRP) on each of the downlink transmit beams using one or more downlink receive beams on the UE 702 and transmit a beam measurement report to the network entity 704 indicating the RSRP of each of the measured downlink transmit beams. The network entity 704 may then select one or more serving downlink beams (e.g., downlink transmit beams and downlink receive beams) for communication with the UE 702 based on the beam measurement report. The resulting selected downlink transmit beam and downlink receive beam may form a downlink beam pair link. In other examples, when the channel is reciprocal, the network entity 704 may derive the particular downlink beam(s) to communicate with the UE 702 based on uplink measurements of one or more uplink reference signals, such as sounding reference signals (SRSs).

In some examples, uplink beams (e.g., uplink transmit beam(s) at the UE 702 and uplink receive beam(s) at the network entity 704) may be selected by measuring the RSRP of received uplink reference signals (e.g., SRSs) or downlink reference signals (e.g., SSBs or CSI-RSs) during an uplink or downlink beam sweep. For example, the network entity 704 may determine the uplink beams either by uplink beam management via an SRS beam sweep with measurement at the network entity 704 or by downlink beam management via an SSB/CSI-RS beam sweep with measurement at the UE 702. The selected uplink beam may be indicated by a selected SRS resource (e.g., time-frequency resources utilized for the transmission of an SRS) when implementing uplink beam management or a selected SSB/CSI-RS resource when implementing downlink beam management. For example, the selected SSB/CSI-RS resource can have a spatial relation to the selected uplink transmit beam (e.g., the uplink transmit beam utilized for the PUCCH, SRS, and/or PUSCH). The resulting selected uplink transmit beam and uplink receive beam may form an uplink beam pair link.

A UE may monitor (e.g., periodically monitor) a set of beam resources associated with a network entity such as a base station and perform beam failure operations to determine whether a beam failure has occurred. In conjunction with this monitoring, the UE may send measurement reports to the network entity that indicate, for example, the received signal strengths measured on the different beam resources.

In conventional beam management (BM) operations, a UE may identify beam qualities and/or beam failures by conducting beam measurements. In some examples, to achieve good performance, beam management operations may consume a relatively significant amount of power and/or involve relatively high overhead. Thus, in some cases, the accuracy of the beam management operations may be limited due to restrictions on power consumption and/or overhead. Moreover, in the event of a beam failure, latency and/or throughput in the system may be negatively impacted by beam recovery operations (e.g., resuming operations on a beam or switching to another beam).

In some examples, a network entity may perform predictive beam management based on artificial intelligence and/or machine learning (AI/ML) algorithms. In some aspects, predictive beam management (e.g., in the spatial domain (SD), the time domain (TD), or the frequency domain (FD)) may reduce power consumption and/or overhead. In some aspects, predictive beam management may provide an improvement in one or more of accuracy, latency, or throughput (e.g., as compared to non-predictive beam management). For example, by predicting non-measured beam qualities, one or more of lower power consumption, lower overhead, or better accuracy may be achieved. As another example, by predicting a future beam blockage or failure, better latency and/or throughput may be achieved.

In some aspects, beam prediction may be a highly non-linear problem. Thus, AI/ML based predictive beam management methods may provide better performance than conventional statistical signaling processing based beam management methods. For example, the prediction of future transmit beam qualities may depend at least in some aspects on a UE's moving speed and/or trajectory, the receive beams used or to be used, interference on the channel, and so on. Given these dependencies, it may be difficult to model a beam prediction based on conventional statistical signaling processing methods.

When predicting beams via AI/ML at a UE or a network entity (e.g., a gNB), there may be a tradeoff between performance and UE power. For example, to predict future downlink transmit beam qualities, a UE may have more observations (e.g., via measurements) than a network entity (e.g., via UE feedback). Thus, prediction at the UE may outperform prediction at the network entity, but may result in higher UE power consumption due to the inference operations.

In addition, training (e.g., model training) at the network entity or at the UE impacts efforts on data collection versus efforts on UE computation. For training at the network entity, data may be collected via an air interface (e.g., an enhanced air interface) or via application layer approaches. For training at the UE, additional UE computation and/or buffering operations may be required (e.g., for both model training and associated data storage).

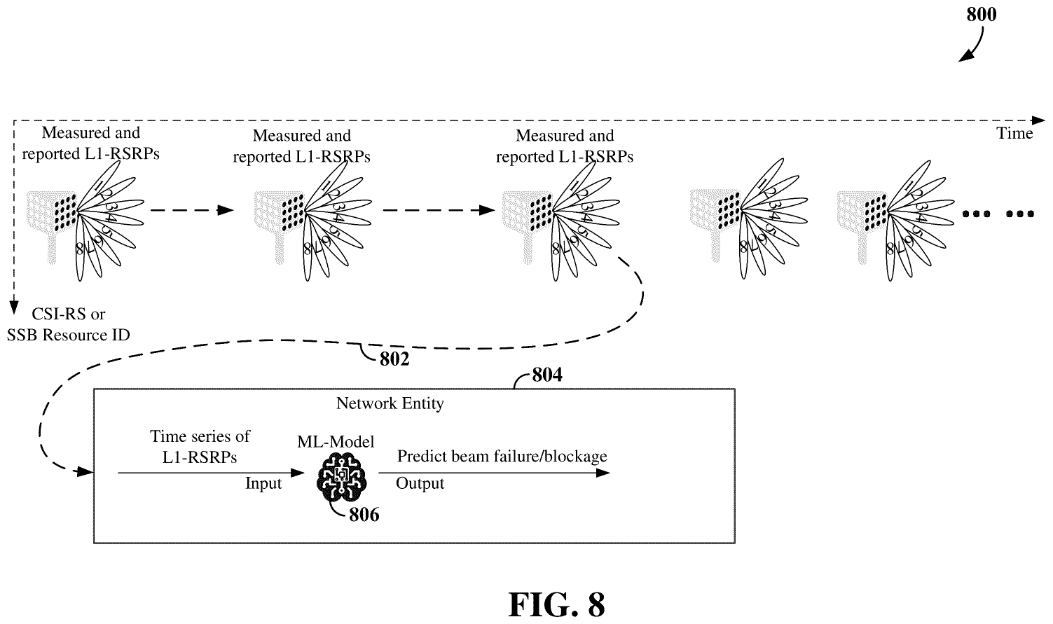

FIG. 8 is a conceptual illustration of an example of a beam prediction operation 800 according to some aspects. A UE (not shown) conducts Layer 1 (L1) RSRP measurements for a set of beams (e.g., beams 1-8) over time (e.g., periodically) and reports the RSRP measurements 802 to a network entity 804 such as a gNB. The RSRP measurements 802 are input to a machine learning (ML) model 806. The ML model 806 provides an output that predicts beam failure or blockage for each beam of the set of beams. In some aspects, the use of such a beam failure prediction procedure may provide, as compared to other beam failure prediction schemes, at least one of a reduction in UE power, a reduction in UE-specific reference signal overhead, an improvement in latency, or an improvement in throughput.

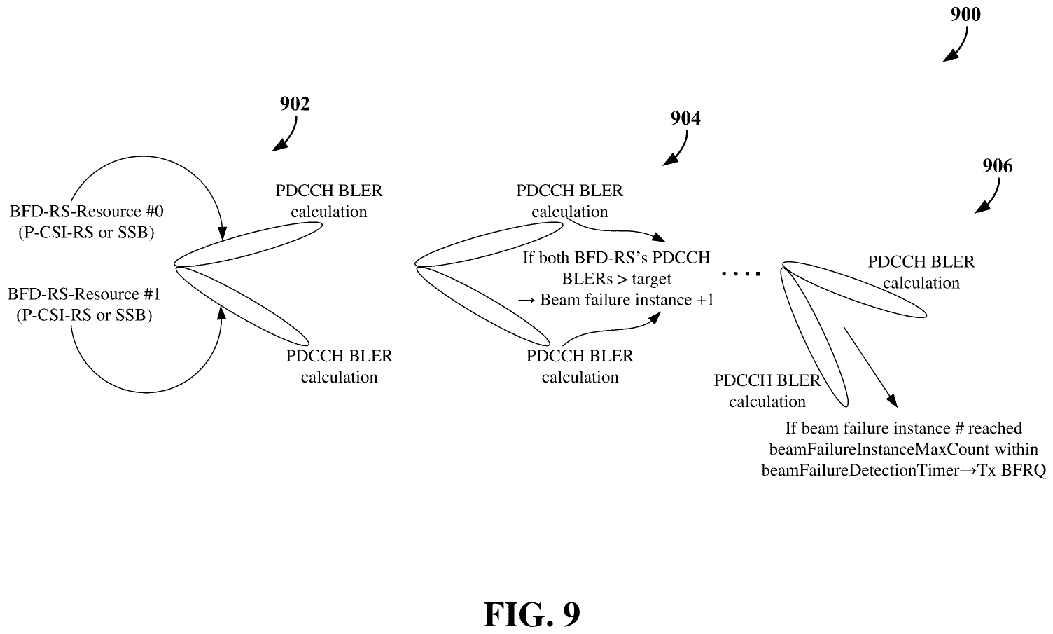

FIG. 9 is a conceptual illustration of an example of beam failure detection operations 900 according to some aspects. There are two beam resources in this example, a beam failure detection reference signal (BFD-RS) resource #0 and a BFD-RS resource 1. These beam resources may carry periodic CSI-RS (P-CSI-RS) signaling, SSB signaling, or some other type of signaling.

At a first operation 902, a UE (not shown) conducts PDCCH block error rate (BLER) calculations for each beam resource. In some examples, the calculation of the BLER involves measuring the RSRP of a received beam and mapping the RSRP value to a BLER value (e.g., based on a table that maps different RSRP values to different BLER values).

At a second operation 904, if the calculated PDCCH BLER for each beam resource is greater than a target BLER threshold, a beam failure instance counter is incremented. At a third operation 906, if the beam failure instance counter reaches a maximum count (e.g., as defined by a parameter beamFailureInstanceMaxCount) within a defined period of time (e.g., as defined by a parameter beamFailureDetectionTimer), the UE transmits a beam failure request (BFRQ).

As mentioned above, a UE may conduct signal measurement such as RSRP measurements and/or received signal strength indication (RSSI) measurements in conjunction with beam management operations. In the event a beam is blocked (e.g., due to a pedestrian, a vehicle, or some other object), there may a drop in the measured RSSI or RSRP. A link degradation time may be defined as the time taken for RSSI or RSRP to drop from its steady state value to its minima or a loss of link (whichever comes earlier). In some examples, the RSSI or RSRP degradation due to blockage may result in a time scale of change that is relative slow (e.g., it may take a few 100 ms for RSSI to drop significantly). In some examples, body blockage measurements (e.g., with a human walking very close to the transmitter and/or receiver) can induce losses on the order of 0.4 dB per ms (diffraction loss). The disclosure relates in some aspects to predicting these and other types of blockages and modifying beam failure operations based on these predictions.

In one example of a BFD-RS configuration, for a certain BWP within a certain serving cell, the reference signal (RS) for detecting beam failure is BWP-specific configured by a radioLinkMonitoringConfig parameter that includes a failure DetectionResourcesToAddModList parameter, which includes a set q̅₀ of at most two periodical CSI-RS or SSB resource indexes. In some examples, a UE expects the set q̅₀ to include at most two single port CSI-RS/SSB resources. In some examples, only periodic CSI-RS resources or SSBs are expected by the UE. In some examples, if the RS is a CSI-RS, only a single port is expected by the UE.

If the failureDetectionResourcesToAddModList parameter is not configured, the UE may instead determine the set q̅₀ as including P-CSI-RS resource indexes that are indicated by the transmission configuration indication (TCI) state (TCI-State) for respective CORESETs that the UE uses for monitoring PDCCH. In some examples, if there are two RS indexes in a TCI state, the set q̅₀ includes RS indexes configured with qcl-Type set to typeD for the corresponding TCI states. In some examples, the UE expects the set q̅₀ to include at most two single port CSI-RS/SSB resources. In some examples, only a single port CSI-RS in set q̅₀ is expected by the UE.

As discussed above in conjunction with FIG. 9, for beam failure detection, a UE may monitor BFD-RSs to determine whether a beam failure trigger condition is met. At L1, this may involve checking whether the PDCCH BLER meets a target BLER level for all beam detection RSs. If so, L1 processing may inform L2 processing of a beam failure instance regarding the serving cell. In addition, the L2 processing may trigger a BFRQ transmission if it receives a certain number of beam failure instances (e.g., an RRC configured beamFailureInstanceMaxCount parameter) from the L1 processing, within a certain duration (e.g., an RRC configured beamFailureDetectionTimer parameter).

In some scenarios, among the two network entity-configured BFD-RS resources, only one of them may predicted to be blocked. In this case, the network entity may fully or partially suspend that BFD-RS resource. In some examples, this prediction may also specify the duration of the blockage.

If a certainty level of the prediction (e.g., generated by the ML model) is high, the network entity can request the UE to fully suspend monitoring of the BFD-RS resource predicted to be blocked, during the predicted blockage duration. Otherwise, the network entity can alternatively request the UE to lower the monitoring frequency of (e.g., partially suspend) the BFD-RS resource predicted to be blocked, depending on the certainty level associated with the prediction, during the predicted blockage duration.

The disclosure relates in some aspects to adjusting the criteria to be used for determining whether a BFRQ should be transmitted depending on the detailed suspension of the BFD-RS resource predicted to be blocked. For example, if a first BFD-RS resource is fully suspended, determining whether a BFRQ should be transmitted may be solely dependent on the identified PDCCH hypothesis BLER associated with the other remaining BFD-RS(s). However, if one of the BFD-RS is predicted to be blocked but predicted to be recovered soon, the criteria for triggering a BFRQ based on the remaining BFD-RS(s) may be stricter (as compared to the fully blocked scenario) since the resources (e.g., contention-free random access (CFRA) resources) used for transmitting a BFRQ may be important (e.g., relatively scarce) resources for the network entity. Here, given that the blocked beam may be recovered soon, liberal transmissions of BFRQs may be deemed to be undesirable (e.g., a waste of important resources).

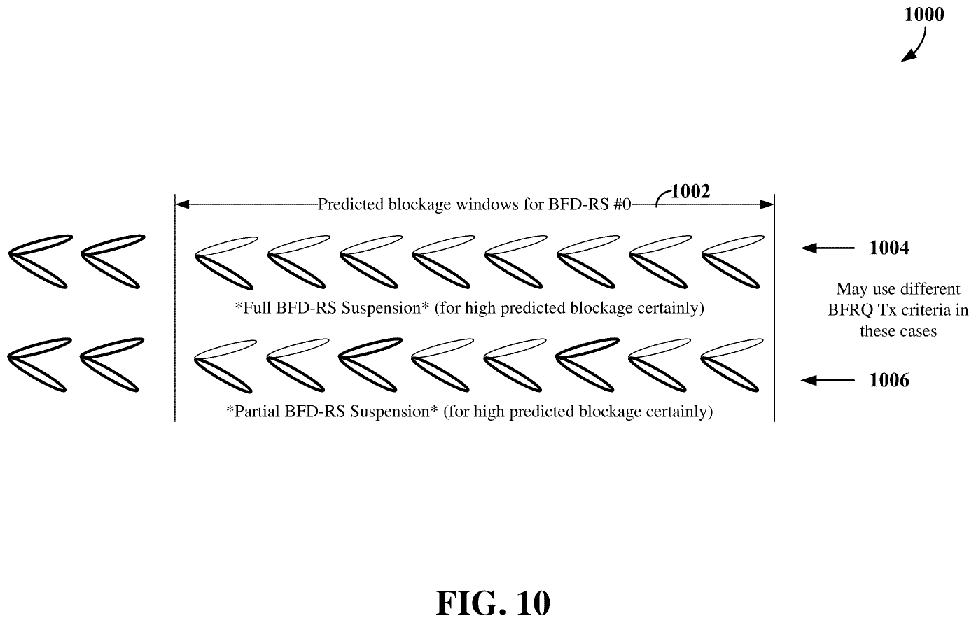

FIG. 10 is a conceptual illustration of an example of a predicted blockage window and suspension conditions 1000 according to some aspects. In this example, a predicted blockage window 1002 may be defined for either a fully suspended BFD-RS resource condition 1004 or for a partially suspended BFD-RS resource condition 1006. In the fully suspended BFD-RS resource condition 1004, all instances of BFD-RS #0 are fully blocked (as indicated by the thinner beam lines in FIG. 10) during the predicted blockage window 1002. In the partially suspended BFD-RS resource condition 1006, only some instances of BFD-RS #0 are blocked (as indicated by the thinner beam lines in FIG. 10) during the predicted blockage window 1002. In accordance with the teachings herein, different BFRQ transmission trigger parameters may be defined for these scenarios (e.g., different parameters as compared to the parameters used for scenarios where there is no suspension).

The disclosure relates in some aspects to signaling enhancements to indicate fully or partially suspended BFD-RS resources and to associated suspension behaviors. The disclosure relates in some aspects to different examples of beam failure triggering conditions considering full or partial suspensions of such BFD-RS resources.

The disclosure relates in some aspects to suspension of a single BFD-RS (e.g., for partial beam blockage). A UE is indicated by the network entity to suspend determining the PDCCH hypothesis BLER regarding a first BFD-RS resource (e.g., BFD-RS resource #0) out of the multiple configured BFD-RS resources. The indication of the suspension may also include a time window for the UE to apply the suspension. The indication of the suspension may include a certainty level (e.g., in terms of %) associated with the suspension. In this case, the UE fully suspends (or partly suspends) determining the PDCCH hypothesis BLER for the first BFD-RS resource, during the time window indicated by the network entity. Such a suspension command can be signaled from the network entity to the UE via MAC-CE signaling, DCI signaling, or some other type of signaling.

The disclosure relates in some aspect to certain conditions to be applied for a full BFD-RS suspension as compared to a partial BFD-RS suspension. In some examples, a UE will fully suspend the first BFD-RS resource with respect to determining the PDCCH hypothesis BLER, based on the certainty level indicated by the network entity being above a first threshold. In some examples, the UE will partly suspend the first BFD-RS resource with respect to determining the PDCCH hypothesis BLER (e.g., the PDCCH BLER is determined less frequently), based on the certainty level indicated by the network entity being below a second threshold. The first threshold and the second threshold can be identical or different. The first threshold and the second threshold can be based on a standard predefinition (e.g., defined by a wireless communication standard such as a 3GPP technical specification) and/or a network entity configuration.

In some examples, a network entity directly indicates to a UE whether the suspension is a full suspension or a partial suspension. For example, the network entity may compare the certainty level to at least one threshold to determine whether the suspension is a full suspension or a partial suspension. In this case, the UE does not need to compare with certainty level to either of the thresholds.

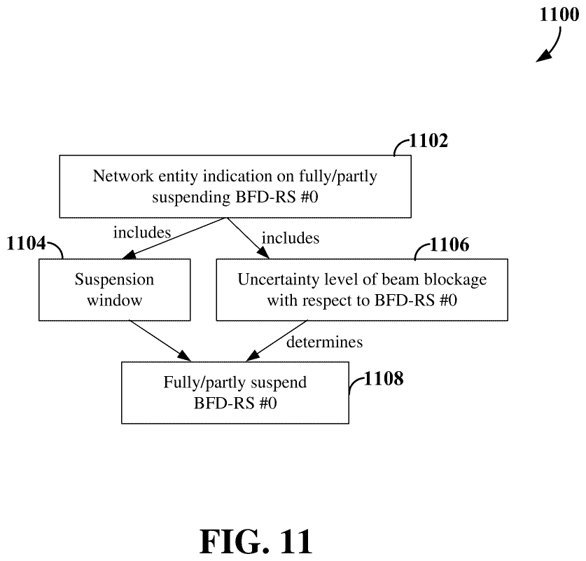

FIG. 11 is a diagram illustrating an example suspension operation 1100 according to some aspects. At block 1102, a network entity such as a gNB sends to a UE an indication of a full or partial suspension of a first BFD-RS resource (e.g., BFD-RS resource #0) of a set of BFD-RS resources used by the network entity. As represented by block 1104, the indication may indicate a suspension window. As represented by block 1106, the indication may indicate an uncertainty level (e.g., a type of certainty level) of the beam blockage (e.g., as predicted by the ML model 806 of FIG. 8). At block 1108, the UE fully or partially suspends the first BFD-RS resource based on the indication.

The disclosure relates in some aspects to beam failure trigger conditions for a full suspension of a first BFD-RS resource (e.g., for BFD-RS #0). In one example (Example 1, Option 1), once the first BFD-RS resource is fully suspended, a different set of beam failure trigger parameters may be used for the other BFD-RS resources.

For example, for all PDCCH hypothesis BLERs associated with any other BFD-RS resource that is different from the first BFD-RS resource, a second beam failure trigger condition is used at Layer 1. In some aspects, this second beam failure trigger condition is different from the conventional beam failure trigger condition associated with all the configured BFD-RS resources, including the first BFD-RS resource. In this case, Layer 2 triggers a BFRQ transmission once it receives a certain number of beam failure instances associated with the second beam failure condition, within a certain duration.

In some examples, such a BFRQ can be transmitted via a different UL resource as compared to the UL resource used for transmitting the conventional BFRQ associated with all configured BFD-RS resources (including the first BFD-RS resource). For example, random access channel (RACH) resources different from the RACH resources associated with the conventional BFRQ, are configured for transmitting such a BFRQ (e.g., for a primary cell (PCell). As another example, for reporting beam failures for secondary cell (SCells), a different MAC-CE may be used to convey the BFRQ for the suspension scenario as compared to the MAC-CE used for conventional BFRQ reporting (e.g., non-suspension scenario).

In some examples, the number of beam failure instances specified for the second beam failure trigger condition (e.g., suspension scenario) can be different from the number of beam failure instances specified for the first beam failure trigger condition (e.g., non-suspension scenario) associated with all configured BFD-RS resources (including the first BFD-RS resource). For example, a beamFailureInstanceMaxCount_Blockage parameter different from the conventionally RRC configured beamFailureInstanceMaxCount, may be RRC configured for beam failure detection during such a beam blockage period.

In some examples, the blockage duration specified for the second beam failure trigger condition (e.g., suspension scenario) can be a different duration as compared to the duration conventionally configured for all BFD-RS resources (including the first BFD-RS resource). For example, a beamFailureDetectionTimer_Blockage parameter different from the conventionally RRC configured beamFailureDetectionTimer, may be RRC configured for beam failure detection during such a beam blockage period.

In some examples, the parameters for the second beam failure trigger condition (e.g., suspension scenario) may be defined to reduce the likelihood or frequency of BFRQ transmissions. For example, the beamFailureInstanceMaxCount_Blockage parameter may be larger than the beamFailureInstanceMaxCount parameter. As another example, the beamFailureDetectionTimer_Blockage parameter may be shorter than the beamFailureDetectionTimer parameter. Here, since the prediction indicates that the blockage will likely occur for only a certain duration, it may be desirable to reduce the processing and signaling associated with BFRQ transmissions (and potential beam recovery operations). Thus, in this case, the network entity may define these parameters to reduce the likelihood that the UE will send a BFRQ.

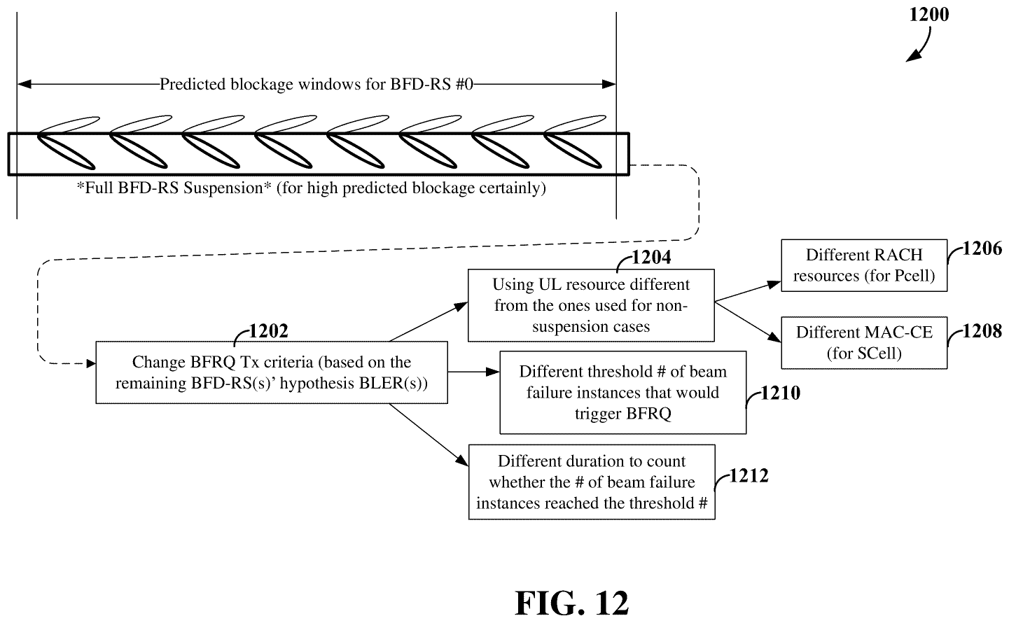

FIG. 12 is a diagram illustrating an example (Example 1, Option 1) of a beam failure trigger operation 1200 according to some aspects. In this example, a predicted blockage window is indicated for a first BFD-RS resource of a set of BFD-RS resources, where the corresponding suspension is a full BFD-RS suspension. At block 1202, a different BFRQ transmission criteria (e.g., different trigger parameters) may be selected for this scenario. As represented by block 1204, different UL resources may be used to transmit the BFRQ as compared the UL resources used for conventional (e.g., non-suspended scenarios) beam failure reporting. For example, different RACH resources may be used for reporting a Pcell (block 1206) beam blockage or a different MAC-CE may be used for reporting an SCell (block 1208) beam blockage. As represented by block 1210, a different beam failure instance threshold may be used to determine whether to transmit the BFRQ as compared the beam failure instance threshold used for conventional (e.g., non-suspended scenarios) beam failure reporting. As represented by block 1212, a different duration threshold may be used to determine whether to transmit the BFRQ as compared the duration threshold used for conventional (e.g., non-suspended scenarios) beam failure reporting.

In another example (Example 1, Option 2), once a first BFD-RS resource is fully suspended, a factor may be applied to the set of beam failure trigger parameters to be used for the other BFD-RS resources. In this way, different effective beam failure trigger parameters will be used for the other BFD-RS resources (e.g., to reduce the likelihood of a BFRQ transmission).

For example, upon every PDCCH hypothesis BLER associated with any other BFD-RS resource that is different from the first BFD-RS resource meeting the BLER threshold, a second beam failure trigger condition is considered to be met with a factor (e.g., having a value less than 1) at Layer 1 (which is different from the beam failure trigger condition associated with all the configured BFD-RS resources, including the first BFD-RS resource). In this case, Layer 2 triggers a BFRQ transmission once it receives a certain number of beam failure instances associated with the second condition, within a certain duration.

In some examples, the factor can be based on a standard predefinition. In some examples, a network entity may configure or indicate the factor to a UE. For example, a wireless communication standard (e.g., a 3GPP technical specification) or a network entity may define associations between the factor and the time window with respect to the first BFD-RS's suspension. Here, a longer duration may lead to greater factor (since the remaining BFD-RS becomes more vulnerable). As another example, a standard or a network entity may define associations between the factor and the certainty level associated with the first BFD-RS's blockage. In some examples, a standard or a network entity may define associations between the factor and the window for counting PDCCH BLERs (e.g., beamFailureDetectionTimer). In some examples, the factor may be indicated together with the indication on BFD-RS resource suspension regarding the first BFD-RS resource.

In this example, the RACH resources, the threshold on the number of beam failures, the duration of the counting, and so on, can all be based on the same RRC configured parameters (e.g., the parameters associated with conventional beam failure detection procedures such as beamFailureInstanceMaxCount and beamFailureDetectionTimer). Thus, suspension specific versions of these parameters are not needed in this case, which may reduce signaling overhead.

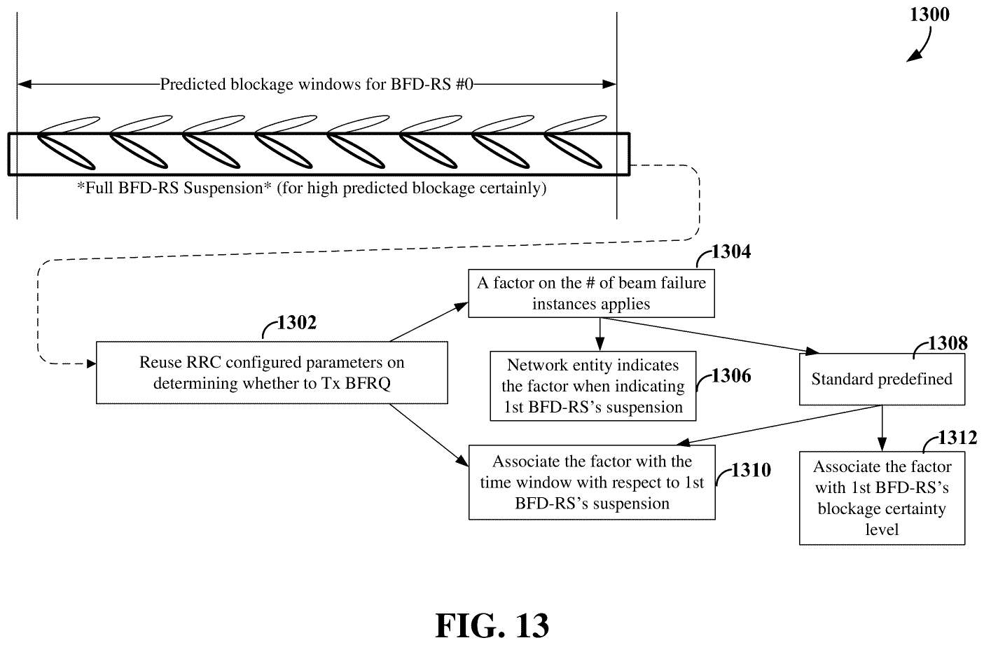

FIG. 13 is a diagram illustrating an example (Example 1, Option 2) of a beam failure trigger operation 1300 according to some aspects. In this example, a predicted blockage window is indicated for a first BFD-RS resource of a set of BFD-RS resources, where the corresponding suspension is a full BFD-RS suspension. At block 1302, conventional BFRQ transmission trigger parameters (e.g., beamFailureInstanceMaxCount and beamFailureDetectionTimer) may be used in this example. As represented by block 1404, a factor may be applied to the number of beam failure instances (e.g., thereby reducing the count that is compared to the conventional count threshold). As represented by block 1406, in some examples, the network entity may signal this factor to the UE. As represented by block 1408, in some examples, this factor may be defined by a wireless communication standard (e.g., 3GPP). As represented by block 1310, in some examples, the factor may be associated with the suspension time window. As represented by block 1312, in some examples, the factor may be associated with the blockage certainty level.

The disclosure relates in some aspects to beam failure trigger conditions for partial suspension of a BFD-RS resource (e.g., a first BFD-RS resource). For predicted blockage regarding the first BFD-RS resource with medium-low certainty levels, the methods introduced in Example 1 (Options 1 and 2) may lead to unfairly declared beam failures. This is because the first BFD-RS may not have failed, but the UE did not measure the first BFD-RS resource as the UE assumed that the PDCCH BLER check would always fail for the first BFD-RS resource during the time window.

In one example (Example 2.1), a UE reduces the PDCCH BLER calculation frequency for the first BFD-RS by a factor of K (e.g., K is an integer), during the time window associated with the suspension indicated by the network entity. In some examples, the value of K can be standard predefined in association with different certainty levels, or indicated by a network entity together with the first BFD-RS suspension command.

In some examples, it is assumed that the PDCCH BLER calculation of the first BFD-RS has failed (e.g., greater than the BLER threshold) for the non-measured occasions. Conventional beam failure operations (e.g., as defined by 3GPP Rel. 17, etc.) may then be used for the remaining beam failure operations.

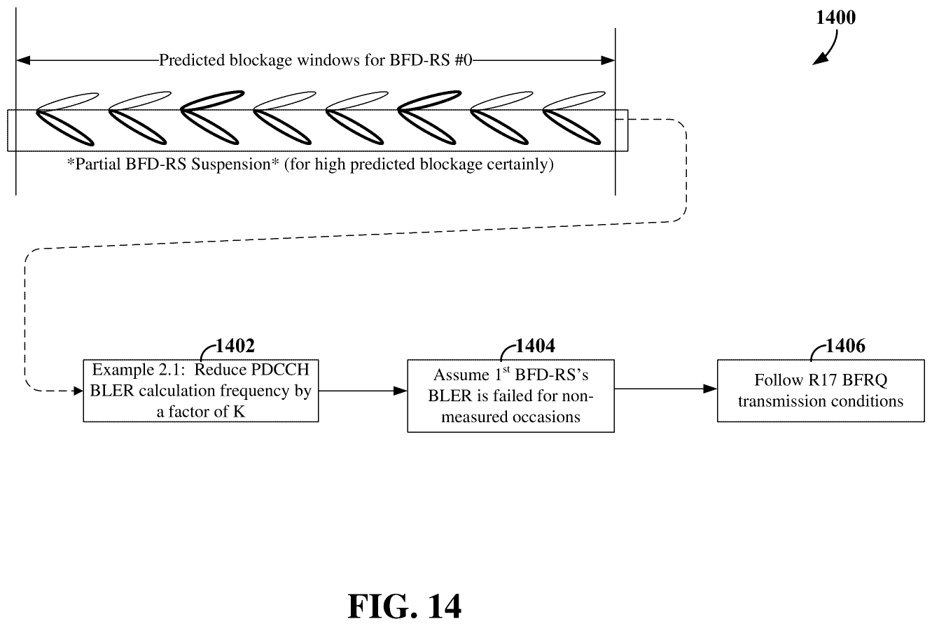

FIG. 14 is a diagram illustrating an example (Example 2.1) of a beam failure trigger operation 1400 according to some aspects. In this example, a predicted blockage window is indicated for a first BFD-RS resource of a set of BFD-RS resources, where the corresponding suspension is a partial BFD-RS suspension. At block 1402, the PDCCH calculation frequency is reduced by a factor K. At block 1404, it is assumed that the non-measured occasions (e.g., the first, second, fourth, fifth, seventh, and eight occasions in the window) failed. At block 1406, conventional BFRQ transmission criteria (e.g., as defined in 3GPP Rel. 17) are followed.

In another example (Example 2.2), the BFRQ triggering conditions of Example 1, Option 1 may be applied to the BFD-RSs other than the first BFD-RS. In some aspects, the two BFD-RSs are considered independently in this example.

For example, if the number of beam failure instances have reached the threshold for Layer 2 to trigger a BFRQ for the other BFD-RSs (the non-blocked beam(s)), the UE may further evaluate the number of instances where the PDCCH hypothesis BLER meets the corresponding BLER threshold associated with the measured instances for the first BFD-RS. If this number with respect to the first BFD-RS is below a certain threshold (e.g., beamFailureInstanceMaxCount_Suspension) over a certain window (e.g., beamFailureDecetectionTimer Suspension), the BFRQ is not transmitted. Otherwise, the BFRQ is transmitted.

Here, the threshold with respect to the first BFD-RS (e.g., beamFailureInstanceMaxCount_Suspension) can be different from the threshold with respect to the threshold introduced in Example 1, Option 1 (e.g., beamFailureInstanceMaxCount_Blockage) and/or different from the conventional threshold used for determining whether to do a BFRQ transmission (e.g., beamFailureInstanceMaxCount). The threshold may be based on a standard predefinition and/or an RRC configuration.

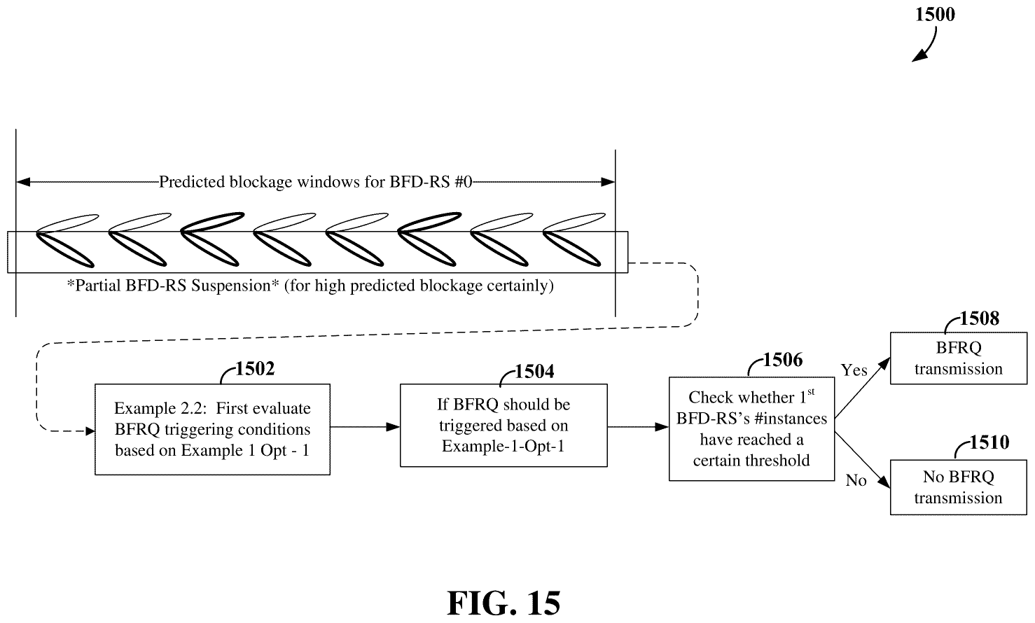

FIG. 15 is a diagram illustrating an example (Example 2.2) of a beam failure trigger operation 1500 according to some aspects. In this example, a predicted blockage window is indicated for a first BFD-RS resource of a set of BFD-RS resources, where the corresponding suspension is a partial BFD-RS suspension. At block 1502, the BFRQ triggering conditions are evaluated according to Example 1, Option 1 discussed above. At block 1504, a determination is made as to whether the BFRQ should be triggered based on the evaluation of block 1502. If so, at block 1506, a determination is made as to whether the beam failure instance count for the first BFD-RS resource has reached the beam failure instance threshold. If so, a BFRQ is transmitted (block 1508). If not, a BFRQ is not transmitted (block 1510).

The disclosure relates in some aspects to extensions to more than two BFD-RS resources (e.g., in a future release, more than two BFD-RS resources may be configured to determine whether BFRQ should be transmitted). A UE can be indicated by a network entity to fully or partially suspend multiple BFD-RS resources for determining PDCCH hypothesis BLER, as in the previous examples.

For an extension to Example 1, Option 1 (all suspended BFD-RS resources are fully suspended), the configured parameters for determining whether to do a BFRQ transmission based on the remaining non-suspended BFD-RS resources can be differently configured for different numbers of suspended BFD-RS resources. For example, with more BFD-RS resources being fully suspended, the associated thresholds on the number of beam failure instances that would trigger a BFRQ transmission can be lower or higher.

For an extension to Example 1, Option 2 (all suspended BFD-RS resources are fully suspended), different factors can be standard predefined or network entity configured for different numbers of suspended BFD-RS resources.

For an extension to Example 2 (at least one of the suspended BFD-RS resources is partly suspended), the configured parameters for determining whether to do a BFRQ transmission based on the remaining non-suspended BFD-RS resources and the partly suspended BFD-RS resources can be differently configured for different combinations of fully and partly suspended BFD-RS numbers and applicable certainty levels.

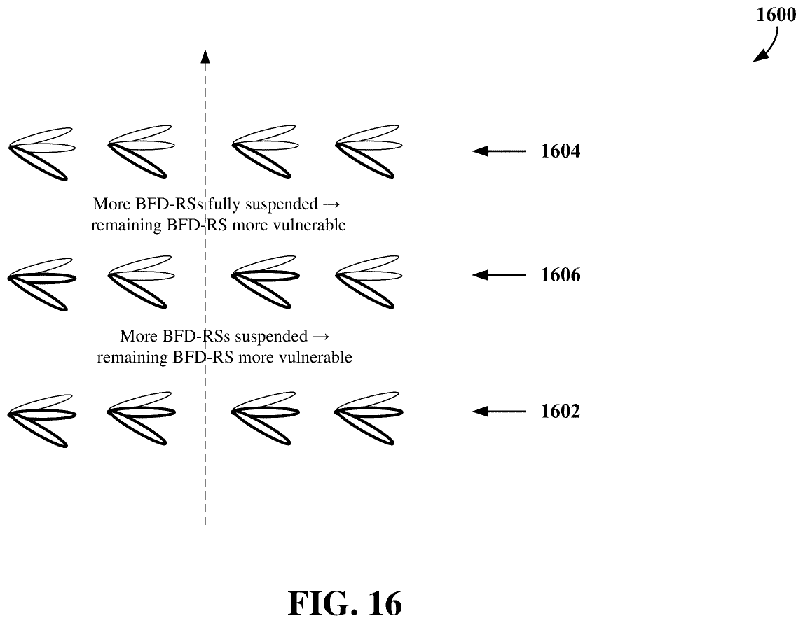

FIG. 16 is a conceptual illustration of an example 1600 of conditions for different parameters according to some aspects. Here, different parameters in Example 1 and Example 2 may be standard predefined or network entity configured, depending on the number of BFD-RS resources being fully and/or partially suspended. For example, a first set of parameters may be used for a first scenario 1602 where a single BFD-RS resource is suspended. Conversely, a second set of parameters may be used for a second scenario 1604 where multiple BFD-RS resources are suspended. In addition, a third set of parameters may be used for a third scenario 1606 where at least one BFD-RS resource is partially suspended.

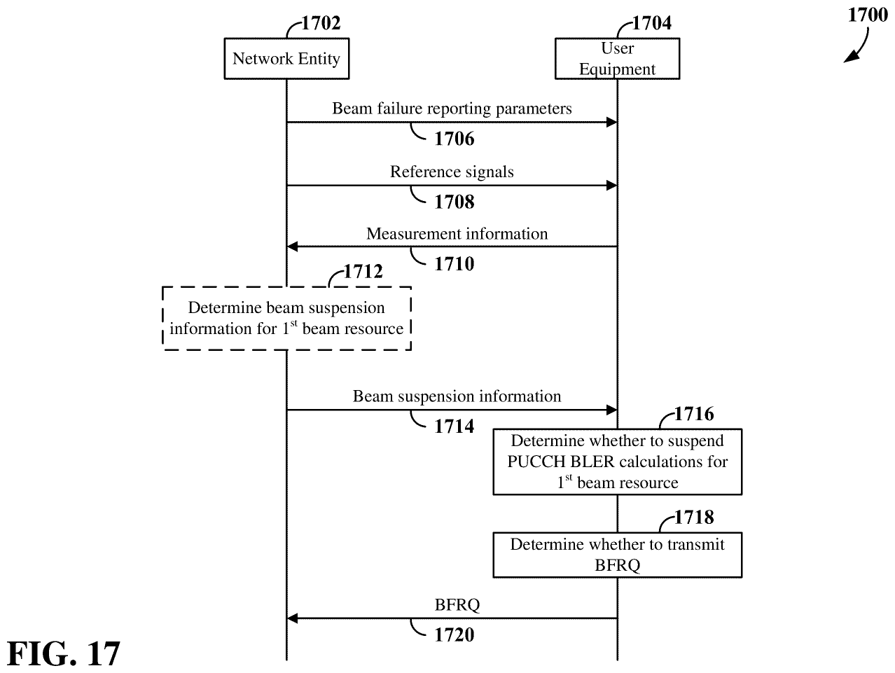

FIG. 17 is a signaling diagram 1700 illustrating an example of a wireless communication system including a network entity 1702 and a user equipment 1704. In some examples, the network entity 1702 may correspond to any of the base stations, CUs, DUs, RUs, or scheduling entities shown in any of FIGS. 1, 2, 3, 5, 6, 7, 8, and 20. In some examples, the user equipment 1704 may correspond to any of the UEs, or scheduled entities shown in any of FIGS. 1, 2, 3, 5, 6, 7, 8, and 18.

At #1706 of FIG. 17, the network entity 1702 sends beam failure reporting parameters to the user equipment 1706 (e.g., via RRC signaling or some other type of signaling). In some examples, the beam failure reporting parameters may include a first set of parameters (e.g., to be used for conventional beam failure reporting operations) and a second set of parameters (e.g., to be used for beam failure reporting operations in a scenario where at least one beam resource is indicated as being at least partially suspended). In some examples, the parameters may include at least one threshold to be compared to a certainty level. In some examples, the parameters may include at least one count threshold. In some examples, the parameters may include at least one duration threshold. In some examples, the parameters may indicate at least one UL resource for transmitting a BFRQ.

At #1708, the network entity 1702 sends reference signals to the user equipment 1706. In some examples, the reference signals may include periodic SSB signaling and/or periodic CSI-RS signaling.

At #1710, the user equipment 1704 sends measurement information to the network entity 1702. For example, in conjunction with beam management operations, the user equipment 1704 may measure the RSRP of received SSB signaling and/or CSI-RS signaling and report this information to the network entity 1702.

At #1712, the network entity 1702 determines whether a beam resource is to be at least partially suspended (e.g., whether beam failure operations for the beam resource are to be at least partially suspended). For example, based on the measurement information received at #1710, the network entity 1702 may predict that a beam block will occur for a particular period of time on a first beam resource of a set of beam resources used by the network entity 1702.

Thus, at #1714, the network entity 1702 may send beam suspension information to the user equipment 1704. In some examples, the beam suspension information may include a certainty level. In some examples, the beam suspension information may include at least one threshold to be compared to a certainty level. In some examples, the beam suspension information may include an indication of whether the first beam resource is to be partially or fully suspended.

At #1716, the user equipment 1704 may determine whether to suspend a beam failure operation on first beam resource indicated by the beam suspension information. For example, based on the beam suspension information received at #1714, the user equipment 1704 may determine whether to fully or partially suspend PUCCH BLER calculations for the first beam resource (e.g., BFD-RS #0).

At #1718, the user equipment 1704 may determine whether to transmit a BFRQ based on measurements of a second beam resource (e.g., BFD-RS #1) of the set of beam resources other than the first beam resource. As discussed herein, this determination may be based on a second set of parameters (e.g., defined for beam failure reporting operations in scenarios where at least one beam resource is indicated as being at least partially suspended).

At #1720, depending on the result of the determination of #1718, the user equipment 1704 may send a BFRQ to the network entity 1702.

FIG. 18 is a block diagram illustrating an example of a hardware implementation for an apparatus 1800 employing a processing system 1814. For example, the apparatus 1800 may be a device configured to wirelessly communicate in a network as discussed in any one or more of FIGS. 1-17. In some implementations, the apparatus 1800 may correspond to any of the UEs or scheduled entities shown in any of FIGS. 1, 2, 3, 5, 6, 7, 8, and 17.

In accordance with various aspects of the disclosure, an element, or any portion of an element, or any combination of elements may be implemented with the processing system 1814. The processing system 1814 may include one or more processors 1804.

Examples of processors 1804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 1800 may be configured to perform any one or more of the functions described herein. That is, the processor 1804, as utilized in an apparatus 1800, may be used to implement any one or more of the processes and procedures described herein.

In this example, the processing system 1814 may be implemented with a bus architecture, represented generally by the bus 1802. The bus 1802 may include any number of interconnecting buses and bridges depending on the specific application of the processing system 1814 and the overall design constraints. The bus 1802 communicatively couples together various circuits including one or more processors (represented generally by the processor 1804), a memory 1805, and computer-readable media (represented generally by the computer-readable medium 1806). The bus 1802 may also link various other circuits such as timing sources, peripherals, voltage regulators, and power management circuits, which are well known in the art, and therefore, will not be described any further. A bus interface 1808 provides an interface between the bus 1802, a transceiver 1810 and an antenna array 1820 and between the bus 1802 and an interface 1830. The transceiver 1810 provides a communication interface or means for communicating with various other apparatus over a wireless transmission medium. The interface 1830 provides a communication interface or means of communicating with various other apparatuses and devices (e.g., other devices housed within the same apparatus as the apparatus 1800 or other external apparatuses) over an internal bus or external transmission medium, such as an Ethernet cable. Depending upon the nature of the apparatus, the interface 1830 may include a user interface (e.g., keypad, display, speaker, microphone, joystick). Of course, such a user interface is optional, and may be omitted in some examples, such as an IoT device.

The processor 1804 is responsible for managing the bus 1802 and general processing, including the execution of software stored on the computer-readable medium 1806. The software, when executed by the processor 1804, causes the processing system 1814 to perform the various functions described below for any particular apparatus. The computer-readable medium 1806 and the memory 1805 may also be used for storing data that is manipulated by the processor 1804 when executing software. For example, the memory 1805 may store beam resource information 1815 (e.g., indicative of BFD-RS resources) used by the processor 1804 for the communication operations described herein.

One or more processors 1804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1806.

The computer-readable medium 1806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1806 may reside in the processing system 1814, external to the processing system 1814, or distributed across multiple entities including the processing system 1814. The computer-readable medium 1806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

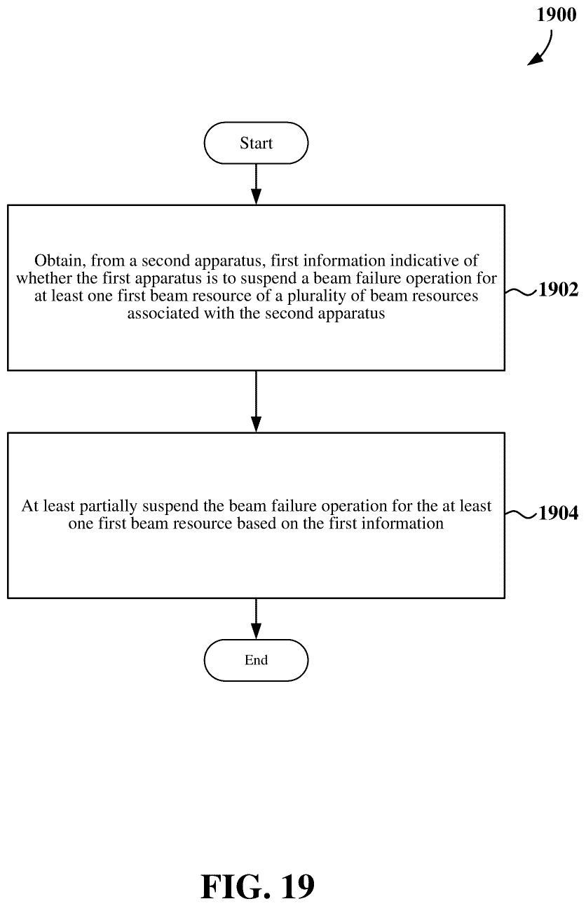

The apparatus 1800 may be configured to perform any one or more of the operations described herein (e.g., as described above in conjunction with FIGS. 1-17 and as described below in conjunction with FIG. 19). In some aspects of the disclosure, the processor 1804, as utilized in the apparatus 1800, may include circuitry configured for various functions.

The processor 1804 may be configured to generate, schedule, and modify a resource assignment or grant of time-frequency resources (e.g., a set of one or more resource elements). For example, the processor 1804 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 1804 may be configured to schedule resources for the transmission of downlink signals. The processor 1804 may further be configured to schedule resources for the transmission of uplink signals.

In some aspects of the disclosure, the processor 1804 may include communication and processing circuitry 1841. The communication and processing circuitry 1841 may be configured to communicate with a user equipment. The communication and processing circuitry 1841 may include one or more hardware components that provide the physical structure that performs various processes related to communication (e.g., signal reception and/or signal transmission) as described herein. The communication and processing circuitry 1841 may further include one or more hardware components that provide the physical structure that performs various processes related to signal processing (e.g., processing a received signal and/or processing a signal for transmission) as described herein. The communication and processing circuitry 1841 may further be configured to execute communication and processing software 1851 included on the computer-readable medium 1806 to implement one or more functions described herein.

The communication and processing circuitry 1841 may further be configured to receive an indication from the UE. For example, the indication may be included in a MAC-CE carried in a Uu PUSCH or a PSCCH, or included in a Uu RRC message or an SL RRC message, or included in a dedicated Uu PUCCH or PUSCH. The communication and processing circuitry 1841 may further be configured to receive a scheduling request from a UE for an uplink grant or a sidelink grant.

In some implementations where the communication involves receiving information, the communication and processing circuitry 1841 may obtain information from a component of the apparatus 1800 (e.g., from the transceiver 1810 that receives the information via radio frequency signaling or some other type of signaling suitable for the applicable communication medium), process (e.g., decode) the information, and output the processed information. For example, the communication and processing circuitry 1841 may output the information to another component of the processor 1804, to the memory 1805, or to the bus interface 1808. In some examples, the communication and processing circuitry 1841 may receive one or more of signals, messages, other information, or any combination thereof. In some examples, the communication and processing circuitry 1841 may receive information via one or more channels. In some examples, the communication and processing circuitry 1841 may receive one or more of signals, messages, SCIs, feedback, other information, or any combination thereof. In some examples, the communication and processing circuitry 1841 may receive information via one or more of a PSCCH, a PSSCH, a PSFCH, some other type of channel, or any combination thereof. In some examples, the communication and processing circuitry 1841 and/or the transceiver 1810 may include functionality for a means for receiving. In some examples, the communication and processing circuitry 1841 may include functionality for a means for decoding. In some examples, the communication and processing circuitry 1841 may include functionality for a means for receiving information from a network entity.

In some implementations where the communication involves sending (e.g., transmitting) information, the communication and processing circuitry 1841 may obtain information (e.g., from another component of the processor 1804, the memory 1805, or the bus interface 1808), process (e.g., encode) the information, and output the processed information. For example, the communication and processing circuitry 1841 may output the information to the transceiver 1810 (e.g., that transmits the information via radio frequency signaling or some other type of signaling suitable for the applicable communication medium). In some examples, the communication and processing circuitry 1841 may send one or more of signals, messages, other information, or any combination thereof. In some examples, the communication and processing circuitry 1841 may send information via one or more channels. In some examples, the communication and processing circuitry 1841 may send one or more of signals, messages, SCIs, feedback, other information, or any combination thereof. In some examples, the communication and processing circuitry 1841 may send information via one or more of a PSCCH, a PSSCH, a PSFCH, some other type of channel, or any combination thereof. In some examples, the communication and processing circuitry 1841 and/or the transceiver 1810 may include functionality for a means for transmitting. In some examples, the communication and processing circuitry 1841 may include functionality for a means for encoding. In some examples, the communication and processing circuitry 1841 may include functionality for a means for transmitting signal measurement information to a network entity.

The processor 1804 may include suspension circuitry 1842 configured to perform suspension-related operations as discussed herein (e.g., one or more of the operations described above in conjunction with FIGS. 8-17). The suspension circuitry 1842 may be configured to execute suspension software 1852 included on the computer-readable medium 1806 to implement one or more functions described herein.

The suspension circuitry 1842 may include functionality for a means for obtaining information (e.g., as described above in conjunction with FIGS. 8-17). For example, the suspension circuitry 1842 may receive, from a network entity, a MAC-CE or DCI that includes information indicative of whether a beam failure operation is to be suspended. As another example, the suspension circuitry 1842 may receive at least one beam failure reporting parameter from a network entity. As a further example, the suspension circuitry 1842 may receive a suspension parameter from a network entity.

The suspension circuitry 1842 may include functionality for a means for at least partially suspending a beam failure operation (e.g., as described above in conjunction with FIGS. 8-17). For example, the suspension circuitry 1842 may determine based on received information (and, optionally, a comparison to a threshold), whether a PDCCH BLER operation is to be partially suspended or fully suspended. The suspension circuitry 1842 may then partially suspend or fully suspend the PDCCH BLER operation accordingly (e.g., for a specified duration of time).

The suspension circuitry 1842 may include functionality for a means for comparing a certainty level to at least one threshold (e.g., as described above in conjunction with FIGS. 8-17). For example, the suspension circuitry 1842 may compare a certainty level received from a network entity to a first threshold or to the first threshold and a second threshold.

The suspension circuitry 1842 may include functionality for a means for obtaining a certainty level (e.g., as described above in conjunction with FIGS. 8-17). For example, the suspension circuitry 1842 may receive, from a network entity, a MAC-CE or DCI that includes a certainty level.

The suspension circuitry 1842 may include functionality for a means for obtaining at least one threshold (e.g., as described above in conjunction with FIGS. 8-17). For example, the suspension circuitry 1842 may receive, from a network entity, a MAC-CE or DCI that includes at least one threshold.

The processor 1804 may include beam failure circuitry 1843 configured to perform beam failure-related operations as discussed herein (e.g., one or more of the operations described above in conjunction with FIGS. 8-17). The beam failure circuitry 1843 may be configured to execute beam failure software 1853 included on the computer-readable medium 1806 to implement one or more functions described herein.

The beam failure circuitry 1843 may include functionality for a means for performing a beam failure operation (e.g., as described above in conjunction with FIGS. 8-17). For example, the beam failure circuitry 1843 may perform PDCCH BLER operations to determine whether a beam failure instance has occurred. As another example, the beam failure circuitry 1843 may determine whether a threshold number of beam failure instances have occurred during a defined period of time.

The beam failure circuitry 1843 may include functionality for a means for outputting a beam failure request message (e.g., as described above in conjunction with FIGS. 8-17). For example, the beam failure circuitry 1843 may send a BFRQ to a network entity in the event a threshold number of beam failure instances have occurred during a defined period of time.

FIG. 19 is a flow chart illustrating an example method 1900 for communication in accordance with some aspects of the present disclosure. As described below, some or all illustrated features may be omitted in a particular implementation within the scope of the present disclosure, and some illustrated features may not be required for implementation of all examples. In some examples, the method 1900 may be carried out by the apparatus 1800 illustrated in FIG. 18. In some examples, the method 1900 may be carried out by any suitable apparatus or means for carrying out the functions or algorithm described below.

At block 1902, the first apparatus may obtain, from a second apparatus, first information indicative of whether the first apparatus is to suspend a beam failure operation for at least one first beam resource of a plurality of beam resources associated with the second apparatus. In some examples, the suspension circuitry 1842, shown and described in FIG. 18, may provide a means to obtain, from a second apparatus, first information indicative of whether the first apparatus is to suspend a beam failure operation for at least one first beam resource of a plurality of beam resources associated with the second apparatus. In some examples, the suspension circuitry 1842 together with the communication and processing circuitry 1841 and the transceiver 1810, shown and described in FIG. 18, may provide a means to obtain, from a second apparatus, first information indicative of whether the first apparatus is to suspend a beam failure operation for at least one first beam resource of a plurality of beam resources associated with the second apparatus. In some examples, the communication and processing circuitry 1841 and/or the transceiver 1810, shown and described in FIG. 18, may provide a means to obtain, from a second apparatus, first information indicative of whether the first apparatus is to suspend a beam failure operation for at least one first beam resource of a plurality of beam resources associated with the second apparatus.

At block 1904, the first apparatus may at least partially suspend the beam failure operation for the at least one first beam resource based on the first information. In some examples, the suspension circuitry 1842, shown and described in FIG. 18, may provide a means to at least partially suspend the beam failure operation for the at least one first beam resource based on the first information.

In some examples, the beam failure operation may include determining a block error rate associated with a physical downlink control channel. In some examples, the at least partial suspension of the beam failure operation may include a partial suspension or a full suspension of the beam failure operation.

In some examples, the first information indicates a suspension period the beam failure operation is to be at least partially suspended. In some examples, the at least partial suspension of the beam failure operation is maintained for the suspension period.

In some examples, the first information may include a certainty level indicative of whether the beam failure operation is to be at least partially suspended. In some examples, the at least partial suspension of the beam failure operation is based on the certainty level.

In some examples, the first information specifies whether the beam failure operation is to be fully suspended or partially suspended. In some examples, the at least partial suspension of the beam failure operation may include partially suspending or fully suspending the beam failure operation based on the first information.

In some examples, the first information may include a certainty level indicative of whether the beam failure operation is to be at least partially suspended. In some examples, the first apparatus may compare the certainty level to at least one threshold. In some examples, the at least partial suspension of the beam failure operation is based on the comparison of the certainty level to the at least one threshold.

In some examples, the first apparatus may obtain the at least one threshold from the second apparatus. In some examples, the at least one threshold is specified by a wireless communication standard.

In some examples, the first information may include a certainty level indicative of whether the beam failure operation is to be at least partially suspended. In some examples, the first apparatus may compare the certainty level to a first threshold. In some examples, the first apparatus may conditionally fully suspend the beam failure operation based on the comparison of the certainty level to the first threshold. In some examples, the at least partial suspension of the beam failure operation may include a full suspension based on the comparison of the certainty level to the first threshold. In some examples, the first apparatus may compare the certainty level to a second threshold. In some examples, the first apparatus may conditionally partially suspend the beam failure operation based on the comparison of the certainty level to the second threshold. In some examples, the at least partial suspension of the beam failure operation may include a partial suspension based on the comparison of the certainty level to the second threshold.

In some examples, the first apparatus may obtain at least one first beam failure reporting parameter to be used for at least one second beam resource of the plurality of beam resources in the event the at least one first beam resource is indicated as being fully suspended. In some examples, the first apparatus may output, for transmission to the second apparatus, a first beam failure request message associated with at least one second beam resource based on the at least one first beam failure reporting parameter.

In some examples, the first beam failure request message is output for transmission via a first uplink resource. In some examples, the first uplink resource is different from a second uplink resource used for outputting a second beam failure request message associated with no beam resources of the plurality of beam resources being indicated as being fully suspended. In some examples, the first uplink resource is different from a second uplink resource configured for a second beam failure request message associated with no beam resources of the plurality of beam resources being indicated as being fully suspended.

In some examples, the at least one first beam failure reporting parameter specifies a first threshold quantity of beam failure instances. In some examples, the outputting of the first beam failure request message for transmission is based, at least in part, on whether a quantity of beam failures instances associated with the at least one second beam resource exceeds the first threshold quantity of beam failure instances. In some examples, the first threshold quantity of beam failure instances is different from a second threshold quantity of beam failure instances associated with no beam resources of the plurality of beam resources being indicated as being fully suspended.

In some examples, the at least one first beam failure reporting parameter specifies a first suspension period. In some examples, the outputting of the first beam failure request message for transmission is based, at least in part, on whether a quantity of beam failures instances associated with the at least one second beam resource occurred during the first suspension period. In some examples, the first suspension period is different from a second suspension period associated with no beam resources of the plurality of beam resources being indicated as being fully suspended.

In some examples, the at least one first beam failure reporting parameter may include at least one factor to be applied to at least one second beam failure reporting parameter associated with no beam resources of the plurality of beam resources being indicated as being fully suspended. In some examples, the at least one factor may include at least one of a first factor associated with threshold quantity of beam failure instances, a second factor associated with a suspension period, or a third factor associated with a certainty level.

In some examples, at least partially suspending the beam failure operation may include partially suspending the beam failure operation according to a suspension parameter. In some examples, the partially suspending the beam failure operation may include reducing a frequency at which a block error rate associated with a physical downlink control channel is calculated. In some examples, the suspension parameter is based on a certainty level. In some examples, the first apparatus may obtain the suspension parameter from the second apparatus. In some examples, the suspension parameter is specified by a wireless communication standard.

In some examples, the first apparatus may obtain at least one first beam failure reporting parameter to be used for at least one second beam resource of the plurality of beam resources in the event the at least one first beam resource is indicated as being partially suspended. In some examples, the first apparatus may output, for transmission to the second apparatus, a first beam failure request message associated with at least one second beam resource based on the at least one first beam failure reporting parameter.

In some examples, the first apparatus may obtain at least one second beam failure reporting parameter associated with no beam resources of the plurality of beam resources being indicated as being partially suspended. In some examples, the at least one second beam failure reporting parameter is different from the at least one first beam failure reporting parameter.

In some examples, the at least one first beam resource may include a plurality of beam resources. In some examples, the first apparatus may obtain at least one first beam failure reporting parameter to be used for at least one second beam resource of the plurality of beam resources. In some examples, the at least one first beam failure reporting parameter is based on how many of the plurality of beam resources are indicated as being at least partially suspended.

In some examples, the first apparatus includes a receiver configured to receive the first information, wherein the first apparatus is configured as a user equipment.

Referring again to FIG. 18, in one configuration, the apparatus 1800 includes means for obtaining, from a network entity, first information indicative of whether the user equipment is to suspend a beam failure operation for at least one first beam resource of a plurality of beam resources associated with the network entity, and means for at least partially suspending the beam failure operation for the at least one first beam resource based on the first information. In one aspect, the aforementioned means may be the processor 1804 shown in FIG. 18 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable medium 1806, or any other suitable apparatus or means described in any one or more of FIGS. 1, 2, 3, 5, 6, 7, 8, 17, and 18, and utilizing, for example, the methods and/or algorithms described herein in relation to FIG. 19.

FIG. 20 is a conceptual diagram illustrating an example of a hardware implementation for an apparatus 2000 employing a processing system 2014. In some implementations, the apparatus 2000 may correspond to any of the network entities, CUs, DUs, RUs, base stations, or scheduling entities shown in any of FIGS. 1, 2, 3, 5, 6, 7, 8, and 17.

In accordance with various aspects of the disclosure, an element, or any portion of an element, or any combination of elements may be implemented with the processing system 2014. The processing system may include one or more processors 2004. The processing system 2014 may be substantially the same as the processing system 1814 illustrated in FIG. 18, including a bus interface 2008, a bus 2002, memory 2005, a processor 2004, a computer-readable medium 2006, a transceiver 2010, and an antenna array 2020. The memory 2005 may store beam resource information 2015 (e.g., indicative of BFD-RS resources) used by the processor 2004 in cooperation with the transceiver 2010 for communication operations as described herein. Furthermore, the apparatus 2000 may include an interface 2030 (e.g., a network interface) that provides a means for communicating with at least one other apparatus within a core network and with at least one radio access network.

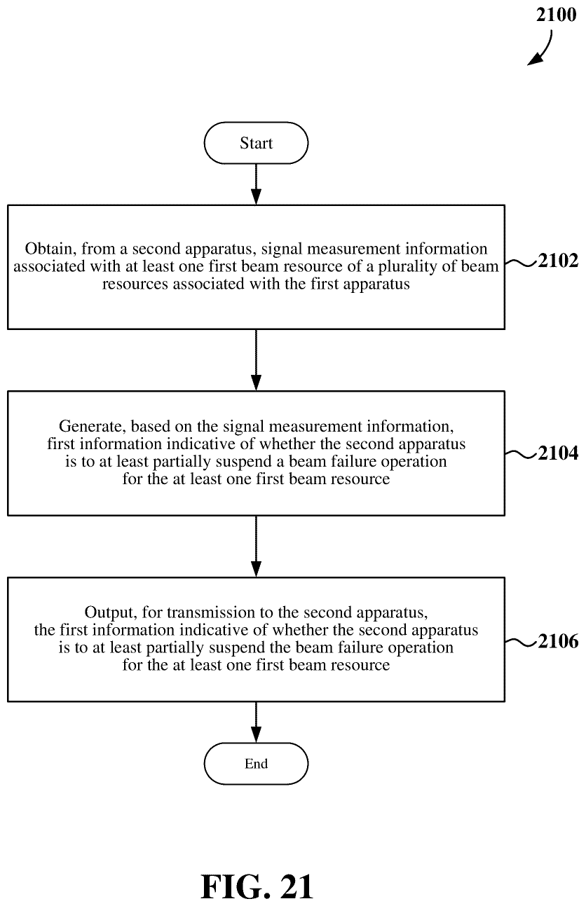

The apparatus 2000 may be configured to perform any one or more of the operations described herein (e.g., as described above in conjunction with FIGS. 1-17 and as described below in conjunction with FIG. 21). In some aspects of the disclosure, the processor 2004, as utilized in the apparatus 2000, may include circuitry configured for various functions.

In some aspects of the disclosure, the processor 2004 may include communication and processing circuitry 2041. The communication and processing circuitry 2041 may be configured to communicate with network entities. The communication and processing circuitry 2041 may include one or more hardware components that provide the physical structure that performs various processes related to communication (e.g., signal reception and/or signal transmission) as described herein. The communication and processing circuitry 2041 may further include one or more hardware components that provide the physical structure that performs various processes related to signal processing (e.g., processing a received signal and/or processing a signal for transmission) as described herein. The communication and processing circuitry 2041 may further be configured to execute communication and processing software 2051 included on the computer-readable medium 2006 to implement one or more functions described herein.

In some implementations wherein the communication involves receiving information, the communication and processing circuitry 2041 may obtain information from a component of the apparatus 2000 (e.g., from the transceiver 2010 that receives the information via radio frequency signaling or some other type of signaling suitable for the applicable communication medium), process (e.g., decode) the information, and output the processed information. For example, the communication and processing circuitry 2041 may output the information to another component of the processor 2004, to the memory 2005, or to the bus interface 2008. In some examples, the communication and processing circuitry 2041 may receive one or more of signals, messages, other information, or any combination thereof. In some examples, the communication and processing circuitry 2041 may receive information via one or more channels. In some examples, the communication and processing circuitry 2041 and/or the transceiver 2010 may include functionality for a means for receiving. In some examples, the communication and processing circuitry 2041 may include functionality for a means for decoding. In some examples, the communication and processing circuitry 2041 may include functionality for a means for receiving signal measurement information from a UE.

In some implementations wherein the communication involves sending (e.g., transmitting) information, the communication and processing circuitry 2041 may obtain information (e.g., from another component of the processor 2004, the memory 2005, or the bus interface 2008), process (e.g., encode) the information, and output the processed information. For example, the communication and processing circuitry 2041 may output the information to the transceiver 2010 (e.g., that transmits the information via radio frequency signaling or some other type of signaling suitable for the applicable communication medium). In some examples, the communication and processing circuitry 2041 may send one or more of signals, messages, other information, or any combination thereof. In some examples, the communication and processing circuitry 2041 may send information via one or more channels. In some examples, the communication and processing circuitry 2041 and/or the transceiver 2010 may include functionality for a means for transmitting. In some examples, the communication and processing circuitry 2041 may include functionality for a means for encoding. In some examples, the communication and processing circuitry 2041 may include functionality for a means for transmitting information to a UE.

The processor 2004 may include suspension circuitry 2042 configured to perform suspension-related operations as discussed herein (e.g., one or more of the operations described above in conjunction with FIGS. 8-17). The suspension circuitry 2042 may be configured to execute suspension software 2052 included on the computer-readable medium 2006 to implement one or more functions described herein.

The suspension circuitry 2042 may include functionality for a means for generating information indicative of whether a beam failure operation is to be at least partially suspended (e.g., as described above in conjunction with FIGS. 8-17). For example, the suspension circuitry 2042 may determine (e.g., based on a comparison of a certainty level to at least one threshold) whether a PDCCH BLER operation is to be partially suspended or fully suspended. The suspension circuitry 2042 may then elect to send an instruction to a UE to partially suspend or fully suspend the PDCCH BLER operation accordingly (e.g., for a specified duration of time).

The suspension circuitry 2042 may include functionality for a means for outputting information (e.g., as described above in conjunction with FIGS. 8-17). For example, the suspension circuitry 2042 may send, to a UE, a MAC-CE or DCI that includes information indicative of whether a beam failure operation is to be at least partially suspended. As another example, the suspension circuitry 2042 may send at least one beam failure reporting parameter to a UE. As a further example, the suspension circuitry 2042 may send a suspension parameter to a UE.

The suspension circuitry 2042 may include functionality for a means for comparing a certainty level to at least one threshold (e.g., as described above in conjunction with FIGS. 8-17). For example, the suspension circuitry 2042 may compare a certainty level calculated by a machine learning model to a first threshold or to the first threshold and a second threshold.

The suspension circuitry 2042 may include functionality for a means for outputting a certainty level (e.g., as described above in conjunction with FIGS. 8-17). For example, the suspension circuitry 2042 may send, to a UE, a MAC-CE or DCI that includes a certainty level.

The suspension circuitry 2042 may include functionality for a means for outputting at least one threshold (e.g., as described above in conjunction with FIGS. 8-17). For example, the suspension circuitry 2042 may send, to a UE, a MAC-CE or DCI that includes at least one threshold to be compared to a certainty level.

The processor 2004 may include beam failure circuitry 2043 configured to perform beam failure-related operations as discussed herein (e.g., one or more of the operations described above in conjunction with FIGS. 8-17). The beam failure circuitry 2043 may be configured to execute beam failure software 2053 included on the computer-readable medium 2006 to implement one or more functions described herein.

The beam failure circuitry 2043 may include functionality for a means for obtaining signal measurement information (e.g., as described above in conjunction with FIGS. 8-17). For example, the beam failure circuitry 2043 may receive a measurement report from a UE that indicates RSRP levels for different beams and input this information to a machine learning model.

The beam failure circuitry 2043 may include functionality for a means for obtaining a beam failure request message (e.g., as described above in conjunction with FIGS. 8-17). For example, the beam failure circuitry 2043 may receive a BFRQ from a

UE in the event the UE determines that a threshold number of beam failure instances have occurred during a defined period of time.

The beam failure circuitry 2043 may include functionality for a means for performing a beam failure operation (e.g., as described above in conjunction with FIGS. 8-17). For example, the beam failure circuitry 2043 may, after receiving a BFRQ from a UE, recover a beam for the UE or establish a new beam for the UE.

In some examples, the apparatus 2000 shown and described above in connection with FIG. 20 may be a disaggregated base station. For example, the apparatus 2000 shown in FIG. 20 may include the CU and optionally one or more DUs/RUs of the disaggregated base station. Other DUs/RUs associated with the apparatus 2000 may be distributed throughout the network. In some examples, the DUs/RUs may correspond to TRPs associated with the network entity. In some examples, the CU and/or DU/RU of the disaggregated base station (e.g., within the apparatus 2000) may generate information indicative of whether a user equipment is to at least partially suspend a beam failure operation and provide the information to the user equipment.

FIG. 21 is a flow chart illustrating an example method 2100 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 2100 may be carried out by the apparatus 2000 illustrated in FIG. 20. In some examples, the method 2100 may be carried out by any suitable apparatus or means for carrying out the functions or algorithm described below.

At block 2102, a first apparatus may obtain, from a second apparatus, signal measurement information associated with at least one first beam resource of a plurality of beam resources associated with the first apparatus. In some examples, the communication and processing circuitry 2041 and the transceiver 2010, shown and described in FIG. 20, may provide a means to obtain, from a second apparatus, signal measurement information associated with at least one first beam resource of a plurality of beam resources associated with the first apparatus. In some examples, the communication and processing circuitry 2041 or the transceiver 2010, shown and described in FIG. 20, may provide a means to obtain, from a second apparatus, signal measurement information associated with at least one first beam resource of a plurality of beam resources associated with the first apparatus.

At block 2104, the first apparatus may generate, based on the signal measurement information, first information indicative of whether the second apparatus is to at least partially suspend a beam failure operation for the at least one first beam resource. In some examples, the suspension circuitry 2042, shown and described in FIG. 20, may provide a means to generate, based on the signal measurement information, information indicative of whether the second apparatus is to at least partially suspend a beam failure operation for the at least one first beam resource.

At block 2106, the first apparatus may output, for transmission to the second apparatus, the first information indicative of whether the second apparatus is to at least partially suspend the beam failure operation for the at least one first beam resource. In some examples, the suspension circuitry 2042, shown and described in FIG. 20, may provide a means to output, for transmission to the second apparatus, the information indicative of whether the second apparatus is to at least partially suspend the beam failure operation for the at least one first beam resource. In some examples, the suspension circuitry 2042 together with the communication and processing circuitry 2041 and the transceiver 2010, shown and described in FIG. 20, may provide a means to output, for transmission to the second apparatus, the information indicative of whether the second apparatus is to at least partially suspend the beam failure operation for the at least one first beam resource. In some examples, the communication and processing circuitry 2041 and/or the transceiver 2010, shown and described in FIG. 20, may provide a means to output, for transmission to the second apparatus, the information indicative of whether the second apparatus is to at least partially suspend the beam failure operation for the at least one first beam resource.

In some examples, the beam failure operation may include determining a block error rate associated with a physical downlink control channel. In some examples, the at least partial suspension of the beam failure operation may include a partial suspension or a full suspension of the beam failure operation.

In some examples, the first information indicates a suspension period the beam failure operation is to be at least partially suspended. In some examples, the first information may include a certainty level indicative of whether the beam failure operation is to be at least partially suspended. In some examples, the first information specifies whether the beam failure operation is to be fully suspended or partially suspended.

In some examples, the first apparatus may output at least one threshold to the second apparatus. In some examples, the at least one threshold is specified by a wireless communication standard.

In some examples, the first apparatus may compare a certainty level to at least one threshold. In some examples, the first information is based on the comparison of the certainty level to the at least one threshold.

In some examples, the first apparatus may compare the certainty level to a first threshold. In some examples, the first apparatus may elect to fully suspend the beam failure operation based on the comparison of the certainty level to the first threshold. In some examples, the first apparatus may compare the certainty level to a second threshold. In some examples, the first apparatus may elect to partially suspend the beam failure operation based on the comparison of the certainty level to the second threshold.

In some examples, the first apparatus may output at least one first beam failure reporting parameter to be used for at least one second beam resource of the plurality of beam resources in the event the at least one first beam resource is indicated as being fully suspended. In some examples, the first apparatus may obtain a first beam failure request message associated with at least one second beam resource based on the at least one first beam failure reporting parameter.

In some examples, the first beam failure request message is obtained via a first uplink resource. In some examples, the first uplink resource is different from a second uplink resource used for obtaining a second beam failure request message associated with no beam resources of the plurality of beam resources being indicated as being fully suspended.

In some examples, the at least one first beam failure reporting parameter specifies a first threshold quantity of beam failure instances. In some examples, obtaining the first beam failure request message is based, at least in part, on whether a quantity of beam failures instances associated with the at least one second beam resource exceeds the first threshold quantity of beam failure instances. In some examples, the first threshold quantity of beam failure instances is different from a second threshold quantity of beam failure instances associated with no beam resources of the plurality of beam resources being indicated as being fully suspended.

In some examples, the at least one first beam failure reporting parameter specifies a first suspension period. In some examples, obtaining the first beam failure request message is based, at least in part, on whether a quantity of beam failures instances associated with the at least one second beam resource occurred during the first suspension period. In some examples, the first suspension period is different from a second suspension period associated with no beam resources of the plurality of beam resources being indicated as being fully suspended.

In some examples, the at least one first beam failure reporting parameter may include at least one factor to be applied to at least one second beam failure reporting parameter associated with no beam resources of the plurality of beam resources being indicated as being fully suspended. In some examples, the at least one factor may include at least one of a first factor associated with threshold quantity of beam failure instances, a second factor associated with a suspension period, or a third factor associated with a certainty level.

In some examples, at least partially suspending the beam failure operation may include partially suspending the beam failure operation according to a suspension parameter. In some examples, the partially suspending the beam failure operation may include reducing a frequency at which a block error rate associated with a physical downlink control channel is calculated.

In some examples, the suspension parameter is based on a certainty level. In some examples, the first apparatus may output the suspension parameter to the second apparatus. In some examples, the suspension parameter is specified by a wireless communication standard.

In some examples, the first apparatus may output at least one first beam failure reporting parameter to be used for at least one second beam resource of the plurality of beam resources in the event the at least one first beam resource is indicated as being at least partially suspended. In some examples, the first apparatus may obtain a first beam failure request message associated with at least one second beam resource based on the at least one first beam failure reporting parameter.

In some examples, the first apparatus may output at least one second beam failure reporting parameter associated with no beam resources of the plurality of beam resources being indicated as being partially suspended. In some examples, the at least one second beam failure reporting parameter is different from the at least one first beam failure reporting parameter.

In some examples, the at least one first beam resource may include a plurality of beam resources. In some examples, the first apparatus may output at least one first beam failure reporting parameter to be used for at least one second beam resource of the plurality of beam resources. In some examples, the at least one first beam failure reporting parameter is based on how many of the plurality of beam resources are indicated as being at least partially suspended.

In some examples, the first apparatus may include a receiver configured to receive the signal measurement information, and a transmitter configured to transmit the information indicative of whether the second apparatus is to at least partially suspend the beam failure operation for the at least one first beam resource, wherein the first apparatus is configured as a network entity.

Referring again to FIG. 20, in one configuration, the apparatus 2000 includes means for obtaining, from a second apparatus, signal measurement information associated with at least one first beam resource of a plurality of beam resources associated with the first apparatus, means for generating, based on the signal measurement information, first information indicative of whether the second apparatus is to at least partially suspend a beam failure operation for the at least one first beam resource, and means for outputting, for transmission to the second apparatus, the first information indicative of whether the second apparatus is to at least partially suspend the beam failure operation for the at least one first beam resource. In one aspect, the aforementioned means may be the processor 2004 shown in FIG. 20 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 2004 is merely provided as an example, and other means for carrying out the described functions may be included within various aspects of the present disclosure, including but not limited to the instructions stored in the computer-readable medium 2006, or any other suitable apparatus or means described in any one or more of FIGS. 1, 2, 3, 5, 6, 7, 8, 17, and 20, and utilizing, for example, the methods and/or algorithms described herein in relation to FIG. 21.

The methods shown in FIGS. 19 and 21 may include additional aspects, such as any single aspect or any combination of aspects described below and/or in connection with one or more other processes described elsewhere herein. The following provides an overview of several aspects of the present disclosure.

Aspect 1: A method for wireless communication at a first apparatus (e.g., a user equipment), the method comprising: obtaining, from a second apparatus, first information indicative of whether the first apparatus is to suspend a beam failure operation for at least one first beam resource of a plurality of beam resources associated with the second apparatus; and at least partially suspending the beam failure operation for the at least one first beam resource based on the first information.

Aspect 2: The method of aspect 1, wherein the beam failure operation comprises determining a block error rate associated with a physical downlink control channel.

Aspect 3: The method of aspect 1 or 2, wherein the at least partial suspension of the beam failure operation comprises a partial suspension or a full suspension of the beam failure operation.

Aspect 4: The method of any of aspects 1 through 3, wherein: the first information indicates a suspension period the beam failure operation is to be at least partially suspended; and the at least partial suspension of the beam failure operation is maintained for the suspension period.

Aspect 5: The method of any of aspects 1 through 4, wherein: the first information comprises a certainty level indicative of whether the beam failure operation is to be at least partially suspended; and the at least partial suspension of the beam failure operation is based on the certainty level.

Aspect 6: The method of any of aspects 1 through 4, wherein: the first information specifies whether the beam failure operation is to be fully suspended or partially suspended; and the at least partial suspension of the beam failure operation comprises partially suspending or fully suspending the beam failure operation based on the first information.

Aspect 7: The method of any of aspects 1 through 4, wherein: the first information comprises a certainty level indicative of whether the beam failure operation is to be at least partially suspended; the method further comprises comparing the certainty level to at least one threshold; and the at least partial suspension of the beam failure operation is based on the comparison of the certainty level to the at least one threshold.

Aspect 8: The method of aspect 7, wherein: the method further comprises obtaining the at least one threshold from the second apparatus; or the at least one threshold is specified by a wireless communication standard.

Aspect 9: The method of any of aspects 1 through 4, wherein: the first information comprises a certainty level indicative of whether the beam failure operation is to be at least partially suspended; the method further comprises comparing the certainty level to a first threshold; and the at least partial suspension of the beam failure operation comprises a full suspension based on the comparison of the certainty level to the first threshold.

Aspect 10: The method of aspect 9, wherein: the method further comprises comparing the certainty level to a second threshold; and the at least partial suspension of the beam failure operation comprises a partial suspension based on the comparison of the certainty level to the second threshold.

Aspect 11: The method of any of aspects 1 through 10, further comprising: obtaining at least one first beam failure reporting parameter to be used for at least one second beam resource of the plurality of beam resources in the event the at least one first beam resource is indicated as being fully suspended; and outputting, for transmission to the second apparatus, a first beam failure request message associated with the at least one second beam resource based on the at least one first beam failure reporting parameter.

Aspect 12: The method of aspect 11, wherein: the first beam failure request message is output for transmission via a first uplink resource; and the first uplink resource is different from a second uplink resource configured for a second beam failure request message associated with no beam resources of the plurality of beam resources being indicated as being fully suspended.

Aspect 13: The method of any of aspects 11 through 12, wherein: the at least one first beam failure reporting parameter specifies a first threshold quantity of beam failure instances; and the outputting of the first beam failure request message for transmission is based, at least in part, on whether a quantity of beam failures instances associated with the at least one second beam resource exceeds the first threshold quantity of beam failure instances.

Aspect 14: The method of aspect 13, wherein: the first threshold quantity of beam failure instances is different from a second threshold quantity of beam failure instances associated with no beam resources of the plurality of beam resources being indicated as being fully suspended.

Aspect 15: The method of any of aspects 11 through 14, wherein: the at least one first beam failure reporting parameter specifies a first suspension period; and the outputting of the first beam failure request message for transmission is based, at least in part, on whether a quantity of beam failures instances associated with the at least one second beam resource occurred during the first suspension period.

Aspect 16: The method of aspect 15, wherein the first suspension period is different from a second suspension period associated with no beam resources of the plurality of beam resources being indicated as being fully suspended.

Aspect 17: The method of any of aspects 11 through 16, wherein the at least one first beam failure reporting parameter comprises at least one factor to be applied to at least one second beam failure reporting parameter associated with no beam resources of the plurality of beam resources being indicated as being fully suspended.

Aspect 18: The method of aspect 17, wherein the at least one factor comprises at least one of: a first factor associated with threshold quantity of beam failure instances, a second factor associated with a suspension period, or a third factor associated with a certainty level.

Aspect 19: The method of any of aspects 1 through 18, wherein at least partially suspending the beam failure operation comprises partially suspending the beam failure operation according to a suspension parameter.

Aspect 20: The method of aspect 19, wherein the partially suspending the beam failure operation comprises reducing a frequency at which a block error rate associated with a physical downlink control channel is calculated.

Aspect 21: The method of any of aspects 19 through 20, wherein at least one of: the suspension parameter is based on a certainty level; the method further comprises obtaining the suspension parameter from the second apparatus; or the suspension parameter is specified by a wireless communication standard.

Aspect 22: The method of any of aspects 1 through 21, further comprising: obtaining at least one first beam failure reporting parameter to be used for at least one second beam resource of the plurality of beam resources in the event the at least one first beam resource is indicated as being partially suspended; and outputting, for transmission to the second apparatus, a first beam failure request message associated with the at least one second beam resource based on the at least one first beam failure reporting parameter.

Aspect 23: The method of aspect 22, wherein: the method further comprises obtaining at least one second beam failure reporting parameter associated with no beam resources of the plurality of beam resources being indicated as being partially suspended; and the at least one second beam failure reporting parameter is different from the at least one first beam failure reporting parameter.

Aspect 24: The method of any of aspects 1 through 23, wherein the at least one first beam resource comprises at least two beam resources.

Aspect 25: The method of any of aspects 1 through 24, wherein: the method further comprises obtaining at least one first beam failure reporting parameter to be used for at least one second beam resource of the plurality of beam resources; and the at least one first beam failure reporting parameter is based on how many of the plurality of beam resources are indicated as being at least partially suspended.

Aspect 26: The method of any of aspects 1 through 25, further comprising: receiving the first information, wherein the first apparatus is configured as a user equipment.

Aspect 27: A method for wireless communication at a first apparatus (e.g., a network entity), the method comprising: obtaining, from a second apparatus, signal measurement information associated with at least one first beam resource of a plurality of beam resources associated with the first apparatus; generating, based on the signal measurement information, first information indicative of whether the second apparatus is to at least partially suspend a beam failure operation for the at least one first beam resource; and outputting, for transmission to the second apparatus, the first information indicative of whether the second apparatus is to at least partially suspend the beam failure operation for the at least one first beam resource.

Aspect 28: The method of aspect 27, further comprising: outputting, for transmission to the second apparatus, at least one first beam failure reporting parameter to be used for at least one second beam resource of the plurality of beam resources in the event the beam failure operation for the at least one first beam resource is indicated as being at least partially suspended.

Aspect 29: The method of aspect 28, wherein the at least one first beam failure reporting parameter specifies a first threshold quantity of beam failure instances.

Aspect 30: The method of aspect 29, wherein the first threshold quantity of beam failure instances is different from a second threshold quantity of beam failure instances associated with no beam resources of the plurality of beam resources being indicated as being fully suspended.

Aspect 31: The method of aspect 28, wherein the at least one first beam failure reporting parameter specifies a first suspension period.

Aspect 32: The method of aspect 31, wherein the first suspension period is different from a second suspension period associated with no beam resources of the plurality of beam resources being indicated as being fully suspended.

Aspect 33: The method of aspect 28, wherein the at least one first beam failure reporting parameter comprises at least one factor to be applied to at least one second beam failure reporting parameter associated with no beam resources of the plurality of beam resources being indicated as being fully suspended.

Aspect 34: The method of aspect 33, wherein the at least one factor comprises at least one of: a first factor associated with threshold quantity of beam failure instances, a second factor associated with a suspension period, or a third factor associated with a certainty level.

Aspect 35: The method of any of aspects 27 through 34, wherein the beam failure operation comprises determining a block error rate associated with a physical downlink control channel.

Aspect 36: The method of any of aspects 27 through 35, wherein the at least partial suspension of the beam failure operation comprises a partial suspension or a full suspension of the beam failure operation.

Aspect 37: The method of any of aspects 27 through 36, wherein the first information indicates a suspension period the beam failure operation is to be at least partially suspended.

Aspect 38: The method of any of aspects 27 through 37, wherein the first information comprises a certainty level indicative of whether the beam failure operation is to be at least partially suspended.

Aspect 39: The method of aspect 38, wherein the method further comprises outputting at least one threshold to the second apparatus.

Aspect 40: The method of any of aspects of any of aspects 27 through 37, wherein the first information specifies whether the beam failure operation is to be fully suspended or partially suspended.

Aspect 41: The method of aspect 40, wherein the method further comprises comparing a certainty level to at least one threshold to determine whether the beam failure operation is to be fully suspended or partially suspended.

Aspect 42: The method of any of aspects 27 through 41, further comprising: obtaining a first beam failure request message via a first uplink resource, wherein the first uplink resource is different from a second uplink resource configured for a second beam failure request message associated with no beam resources of the plurality of beam resources being indicated as being fully suspended.

Aspect 43: The method of any of aspects 27 through 42, further comprising: outputting a suspension parameter, wherein at least partially suspending the beam failure operation comprises partially suspending the beam failure operation according to the suspension parameter.

Aspect 44: The method of aspect 43, wherein the partially suspending the beam failure operation comprises reducing a frequency at which a block error rate associated with a physical downlink control channel is calculated.

Aspect 45: The method of any of aspects 43 through 44, wherein at least one of: the suspension parameter is based on a certainty level; or the suspension parameter is specified by a wireless communication standard.

Aspect 46: The method of any of aspects 27 through 45, further comprising: receiving the signal measurement information; and transmitting the first information indicative of whether the second apparatus is to at least partially suspend the beam failure operation for the at least one first beam resource, wherein the first apparatus is configured as a network entity.

Aspect 47: A user equipment, comprising: at least one transceiver; a memory comprising instructions; and one or more processors configured to execute the instructions and cause the user equipment to perform a method in accordance with any one or more of aspects 1 through 25, wherein the at least one transceiver is configured to receive the first information.

Aspect 48: A first apparatus configured for communication comprising at least one means for performing any one or more of aspects 1 through 26.

Aspect 49: A non-transitory computer-readable medium storing computer-executable code, comprising code for causing a first apparatus to perform any one or more of aspects 1 through 26.

Aspect 50: A first apparatus, comprising: a memory comprising instructions; and one or more processors configured to execute the instructions and cause the first apparatus to perform a method in accordance with any one or more of aspects 1 through 25.

Aspect 47: A network entity, comprising: at least one transceiver; a memory comprising instructions; and one or more processors configured to execute the instructions and cause the network entity to perform a method in accordance with any one or more of aspects 27 through 45, wherein the at least one transceiver is configured to receive the first information.

Aspect 48: A first apparatus configured for communication comprising at least one means for performing any one or more of aspects 27 through 46.

Aspect 49: A non-transitory computer-readable medium storing computer-executable code, comprising code for causing a first apparatus to perform any one or more of aspects 27 through 46.

Aspect 50: A first apparatus, comprising: a memory comprising instructions; and one or more processors configured to execute the instructions and cause the first apparatus to perform a method in accordance with any one or more of aspects 27 through 45.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-21 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 5, 6, 7, 8, 17, 18, and 20 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of′ a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first apparatus for wireless communication, comprising:
a processing system configured to:
obtain, from a second apparatus, first information indicative of whether the first apparatus is to suspend a beam failure operation for at least one first beam resource of a plurality of beam resources associated with the second apparatus; and
at least partially suspend the beam failure operation for the at least one first beam resource based on the first information.

2. The first apparatus of claim 1, wherein the beam failure operation comprises determining a block error rate associated with a physical downlink control channel.

3. The first apparatus of claim 1, wherein the at least partial suspension of the beam failure operation comprises a partial suspension or a full suspension of the beam failure operation.

4. The first apparatus of claim 1, wherein:
the first information indicates a suspension period the beam failure operation is to be at least partially suspended; and
the at least partial suspension of the beam failure operation is maintained for the suspension period.

5. The first apparatus of claim 1, wherein:
the first information comprises a certainty level indicative of whether the beam failure operation is to be at least partially suspended; and
the at least partial suspension of the beam failure operation is based on the certainty level.

6. The first apparatus of claim 1, wherein:
the first information specifies whether the beam failure operation is to be fully suspended or partially suspended; and
the at least partial suspension of the beam failure operation comprises partially suspending or fully suspending the beam failure operation based on the first information.

7. The first apparatus of claim 1, wherein:
the first information comprises a certainty level indicative of whether the beam failure operation is to be at least partially suspended;
the processing system is further configured to compare the certainty level to at least one threshold; and
the at least partial suspension of the beam failure operation is based on the comparison of the certainty level to the at least one threshold.

8. The first apparatus of claim 7, wherein:
the processing system is further configured to obtain the at least one threshold from the second apparatus; or
the at least one threshold is specified by a wireless communication standard.

9. The first apparatus of claim 1, wherein:
the first information comprises a certainty level indicative of whether the beam failure operation is to be at least partially suspended;
the processing system is further configured to compare the certainty level to a first threshold; and
the at least partial suspension of the beam failure operation comprises a full suspension based on the comparison of the certainty level to the first threshold.

10. The first apparatus of claim 9, wherein:
the processing system is further configured to compare the certainty level to a second threshold; and
the at least partial suspension of the beam failure operation comprises a partial suspension based on the comparison of the certainty level to the second threshold.

11. The first apparatus of claim 1, wherein the processing system is further configured to:
obtain at least one first beam failure reporting parameter to be used for at least one second beam resource of the plurality of beam resources in the event the at least one first beam resource is indicated as being fully suspended; and
output, for transmission to the second apparatus, a first beam failure request message associated with the at least one second beam resource based on the at least one first beam failure reporting parameter.

12. The first apparatus of claim 11, wherein:
the first beam failure request message is output for transmission via a first uplink resource; and
the first uplink resource is different from a second uplink resource configured for a second beam failure request message associated with no beam resources of the plurality of beam resources being indicated as being fully suspended.

13. The first apparatus of claim 11, wherein:
the at least one first beam failure reporting parameter specifies a first threshold quantity of beam failure instances; and
the outputting of the first beam failure request message for transmission is based, at least in part, on whether a quantity of beam failures instances associated with the at least one second beam resource exceeds the first threshold quantity of beam failure instances.

14. The first apparatus of claim 13, wherein the first threshold quantity of beam failure instances is different from a second threshold quantity of beam failure instances associated with no beam resources of the plurality of beam resources being indicated as being fully suspended.

15. The first apparatus of claim 11, wherein:
the at least one first beam failure reporting parameter specifies a first suspension period; and
the outputting of the first beam failure request message for transmission is based, at least in part, on whether a quantity of beam failures instances associated with the at least one second beam resource occurred during the first suspension period.

16. The first apparatus of claim 15, wherein the first suspension period is different from a second suspension period associated with no beam resources of the plurality of beam resources being indicated as being fully suspended.

17. The first apparatus of claim 11, wherein the at least one first beam failure reporting parameter comprises at least one factor to be applied to at least one second beam failure reporting parameter associated with no beam resources of the plurality of beam resources being indicated as being fully suspended.

18. The first apparatus of claim 17, wherein the at least one factor comprises at least one of: a first factor associated with threshold quantity of beam failure instances, a second factor associated with a suspension period, or a third factor associated with a certainty level.

19. The first apparatus of claim 1, wherein at least partially suspending the beam failure operation comprises partially suspending the beam failure operation according to a suspension parameter.

20. The first apparatus of claim 19, wherein the partially suspending the beam failure operation comprises reducing a frequency at which a block error rate associated with a physical downlink control channel is calculated.

21. The first apparatus of claim 19, wherein at least one of:
the suspension parameter is based on a certainty level;
the processing system is further configured to obtain the suspension parameter from the second apparatus; or
the suspension parameter is specified by a wireless communication standard.

22. The first apparatus of claim 1, wherein the processing system is further configured to:
obtain at least one first beam failure reporting parameter to be used for at least one second beam resource of the plurality of beam resources in the event the at least one first beam resource is indicated as being partially suspended; and
output, for transmission to the second apparatus, a first beam failure request message associated with the at least one second beam resource based on the at least one first beam failure reporting parameter.

23. The first apparatus of claim 22, wherein:
the processing system is further configured to obtain at least one second beam failure reporting parameter associated with no beam resources of the plurality of beam resources being indicated as being partially suspended; and
the at least one second beam failure reporting parameter is different from the at least one first beam failure reporting parameter.

24. The first apparatus of claim 1, wherein the at least one first beam resource comprises at least two beam resources.

25. The first apparatus of claim 1, wherein:
the processing system is further configured to obtain at least one first beam failure reporting parameter to be used for at least one second beam resource of the plurality of beam resources; and
the at least one first beam failure reporting parameter is based on how many of the plurality of beam resources are indicated as being at least partially suspended.

26. A user equipment for wireless communication, comprising:
a transceiver; and
a processing system configured to:
receive, from a network entity via the transceiver, first information indicative of whether the user equipment is to suspend a beam failure operation for at least one first beam resource of a plurality of beam resources associated with the network entity; and
at least partially suspend the beam failure operation for the at least one first beam resource based on the first information.

27. A first apparatus for wireless communication, comprising:
a processing system configured to:
obtain, from a second apparatus, signal measurement information associated with at least one first beam resource of a plurality of beam resources associated with the first apparatus;
generate, based on the signal measurement information, first information indicative of whether the second apparatus is to at least partially suspend a beam failure operation for the at least one first beam resource; and
output, for transmission to the second apparatus, the first information indicative of whether the second apparatus is to at least partially suspend the beam failure operation for the at least one first beam resource.

28. The first apparatus of claim 27, wherein the processing system is further configured to:
output, for transmission to the second apparatus, at least one first beam failure reporting parameter to be used for at least one second beam resource of the plurality of beam resources in the event the beam failure operation for the at least one first beam resource is indicated as being at least partially suspended.

29. The first apparatus of claim 28, wherein the at least one first beam failure reporting parameter specifies a first suspension period.

30. The first apparatus of claim 27, further comprising:
a transceiver configured to receive the signal measurement information and transmit the first information indicative of whether the second apparatus is to at least partially suspend the beam failure operation for the at least one first beam resource,
wherein the first apparatus is configured as a network entity.
